(19) United States
(12) Patent Application Publication
(10) Pub. No.: US 2010/0129632 A1
(43) Pub. Date: May 27, 2010

(54) MULTI-LAYER STRETCH FILM

(75) Inventors: George N. Eichbauer, Bishop, GA (US); Alexander Tukachinsky, Jefferson, MA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/623,377

(22) Filed: Nov. 21, 2009

Related U.S. Application Data
(60) Provisional application No. 61/117,043, filed on Nov. 21, 2008.
(60) Provisional application No. 61/117,057, filed on Nov. 21, 2008.
(60) Provisional application No. 61/117,062, filed on Nov. 21, 2008.
(60) Provisional application No. 61/117,067, filed on Nov. 21, 2008.

(51) Int. Cl. B32B 27/32; B32B 27/08; B32B 7/00

(52) U.S. Cl. 428/220; 428/523; 428/516

(57) ABSTRACT

A multi-layer stretch film having several polyolefin layers.

This application claims priority to co-pending U.S. Provisional Patent Application Ser. Nos. 61/117,043; 61/117,057; 61/117,062; and, 61/117,067, all of which were filed Nov. 21, 2008, entitled “Multi-Layer Stretch Film,” the disclosures of which are incorporated herein by reference in their entirety.

### BACKGROUND

The present disclosure relates to multi-layer stretch films, and to a method of making the same. More particularly, the present disclosure relates to a polymeric co-extruded multi-layer film and a process for making the same.

### SUMMARY

According to the present disclosure, a multi-layer stretch film includes a first exterior sheet, a second exterior sheet, and a core. One or more layers is included in the core.

In illustrative embodiments, a multi-layer polymeric stretch film having seven or more layers is described. In one embodiment, the polymeric stretch film has eleven layers. Various different polymers can be used in the layers. Some polymers do not form films well with other polymers; the polymers are incompatible. This incompatibility is, in part, overcome by including one or more compatibilizing layers within the film structure. In one aspect, combining incompatible polymer layers by using compatibilizing polymer layers provides films with unique attributes. In particular, polymers with desirable properties can be combined even when those polymers are incompatible. The film has properties that make it useful for stretch-wrap packaging; particularly, the multi-layer stretch film of the present disclosure has a structure which allows for obtaining desirable properties with thinner films.

In illustrative embodiments, the structures described herein provide for enhanced film properties (load retention, puncture resistance, tear resistance, tensile strength, extensibility, cling properties, and non-cling properties). In one aspect, the enhancement is a result of the attributes being decoupled. A polymer providing good tear resistance may have poor puncture resistance and vice versa. If these polymers are incompatible, increasing the tear resistance of a film may result in a decrease in puncture resistance; these properties are coupled. However, using compatibilizing layers as described herein, the incompatibility of the polymers can be overcome and it is possible to decouple the film's properties. Accordingly, films in accordance with the present disclosure can be manufactured to have both increased tear resistance and increased puncture resistance. While an absolute increase in these properties may not be necessary for a given application, increasing the films performance allows the thickness of the film to be decreased while the properties still meet the demands of a given use. This decrease in thickness, called down-gauging, decreases the amount of polymer needed to make the film. Down-gauging saves money and is desirable from an environmental perspective.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a multi-layer stretch film in accordance with one illustrative embodiment of the present disclosure showing a first exterior sheet including a non-cling layer and an intermediate layer, a core, and a second exterior sheet including an intermediate layer and a cling layer and showing that the core comprises, in series, a first catalyzed polyethylene sheet, an interior polymer bed including a first polymer buffer sheet, a polymer sheet, and a second polymer buffer sheet, and a second catalyzed polyethylene sheet;

FIG. 2 is a diagrammatic view of a multi-layer stretch film in accordance with the present disclosure showing that in an illustrative embodiment the stretch film comprises, in series, a first exterior sheet, a core, and a second exterior sheet and showing that the core comprises, in series, a first catalyzed polyethylene polymer sheet, an interior polymer bed including a first polymer buffer sheet, a polymer sheet, and a second polymer buffer sheet, and a second catalyzed polyethylene polymer sheet;

FIG. 3 is a diagrammatic view of a multi-layer stretch film in accordance with the present disclosure showing that in an illustrative embodiment the stretch film comprises, in series, a first exterior sheet, a core, and a second exterior sheet and showing that the core comprises, in series, a first outer polymer bed, an interior polymer bed, and a second outer polymer bed; wherein the first and second outer polymer bed includes a first, second, and third catalyzed polyethylene layer and the interior polymer bed includes a first outer layer, a center layer, and a second outer layer;

FIG. 4 is a diagrammatic view of a multi-layer stretch film in accordance with the present disclosure showing that in an illustrative embodiment the stretch film comprises, in series, a first exterior sheet, a core, and a second exterior sheet and showing that the core comprises, in series, a first outer polymer bed, an interior polymer bed, and a second outer polymer bed; wherein the first and second outer polymer bed includes a first, second, third and fourth catalyzed polyethylene layer;

FIG. 5 is a diagrammatic view of a multi-layer stretch film in accordance with the present disclosure showing that in an illustrative embodiment the stretch film comprises, in series, a first exterior sheet, a core, and a second exterior sheet and showing that the core comprises, in series, a number (N) of polymer sheets; wherein the polymer sheets include a first catalyzed polyethylene layer, an EP copolymer layer, and a second catalyzed polyethylene layer;

FIG. 6 is a diagrammatic view of a multi-layer stretch film in accordance with the present disclosure showing that in an illustrative embodiment the stretch film comprises, in series, a first exterior sheet, a core, and a second exterior sheet and showing that the core comprises, in series, a first outer core layer, a first core buffer layer, a center layer, a second core buffer layer, and a second outer core layer; wherein the polymer sheets include a first buffer layer and a second buffer layer;

FIG. 7A is a diagrammatic view of a multi-layer stretch film in accordance with the present disclosure showing that in an illustrative embodiment the stretch film (A) comprises, in series, a first exterior sheet, a core, and a second exterior sheet and showing that the core comprises, in series, a number (N) of polymer sheets; wherein the polymer sheets (B) include a first catalyzed polyethylene layer, a first elastomer layer, an EP copolymer layer, a second elastomer layer, and a second catalyzed polyethylene layer; and

FIG. 7B is a is a diagrammatic view of a polymer sheet in accordance with the present disclosure showing that in an illustrative embodiment the polymer sheet comprises, in series, a first catalyzed polyethylene layer, a first elastomer layer, an EP copolymer layer, a second elastomer layer, and a second catalyzed polyethylene layer.

### DETAILED DESCRIPTION

The present disclosure is related to multi-layer stretch films comprising a first exterior sheet, a second exterior sheet and a core. The core is interposed between the first exterior sheet and a second exterior sheet.

The present disclosure describes a multi-layer stretch film or process for making the same that takes advantage of our discovery that decoupling is possible by arranging the layers of the multi-layer film as described herein. Specifically, the arrangements described herein enable the cooperation of disparate layers in a way such that the overall film properties exceed the properties that one would expect from a blend of the resins. The structural and compositional features described herein decouple the attributes associated with the layers from the accompanying detriments by combining layers with complimentary features.

In one sense, the term decoupling encompasses the enhancement of two or more physical properties concurrently through specifically tailoring the film's structure to a particular strategy. In another sense, the term decoupling encompasses the enhancement of one or more physical properties with a film composition or the process for making the same which does not cause a significant adverse effect on any other physical property. Furthermore, decoupling encompasses the enhancement of one or more physical properties with a film composition or the process for making the same which causes fewer or a lesser degree of adverse effects than what is typically expected. An important aspect and surprising result of decoupling is that film properties which are typically considered to be inversely proportional can be made to improve according to a direct relationship (a synergistic manner). When attributes are not concurrently improved, a surprising result of decoupling is that film properties which are inversely proportional can be made to independent. The improvement of film attributes is accomplished through combining different resins, using different process conditions, or combining resins in a different film structure. The improvement is ascertained by comparing the present film's properties with a prior film or a competitor film.

For example, an improvement in elongation is typically observed by using a lower molecular weight resin. However, the lower molecular weight resin typically results in a decreased puncture resistance. However, by incorporating the lower molecular weight resin into one layer of the present disclosure flanked by a compatibilizing layer and/or a high molecular weight resin, an improvement in elongation can be achieved without adversely affecting the puncture resistance.

Similarly, improvements in tear resistance have previously been coupled to a decrease in load-retention properties. However, the present disclosure contains film structures in which tear resistance can be improved without a significant decrease in load retention properties. A discovery that made the present disclosure possible is that the physical properties of multi-layered films can be decoupled through appropriate layer combinations and the processes for combining those layers. Within the scope of this discovery is the importance of the microcrystalline structure to the chemical and physical (often construed as rheological) compatibility between the layers. As used herein, the term compatibility includes rheological compatibility (flow), chemical compatibility, layer to layer adhesive force compatibility, or interface entanglement compatibility. One example of compatibility includes the selection of resins that would result in a monotonic change in melt viscosity of layers between the core and the skin of the film; such orientation focusing on rheological compatibility.

The microcrystalline structure may in part be controlled by copolymerization conditions which lead to block copolymers, random copolymers, short-chain branching, long-chain branching, and diversely-branched copolymers. With various monomers being incorporated at various levels into the molecular structure of a polymer, the diversity of resins that can be created is nearly limitless. One aspect of the present disclosure is that the embodiments disclosed herein selectively combine the appropriate polymers based on a primary property (load retention, puncture resistance, tear resistance, tensile strength, extensibility, cling properties, non-cling properties, etc.) with consideration of the microcrystalline orientation of that polymer and that of the immediately adjacent layers.

One aspect of the present disclosure is that microcrystalline structure from one layer can seed crystallization in adjacent layers which may in some situations lead to enhanced inter-layer compatibility. Another aspect of the present disclosure is that adjacent layers having similar rheological properties (good rheological compatibility) may be selected to have disparate microcrystalline structure. Since microcrystalline structure influences physical properties, the primary properties associated with the microcrystalline structure can be decoupled from the rheological compatibility with the end result being a multi-layer film exhibiting enhanced physical properties.

Another aspect of the present disclosure is that the inclusion of compatibilizing layers facilitates rheological compatibility between adjacent layers that was heretofore not possible. Including layers with poor interlayer compatibility is now possible through the incorporation of the interposed layers which have good or adequate interlayer compatibility with each of the adjacent layers. In illustrative embodiments, the interposed layer may be a buffer layer. For example, we have determined that an elastomer, plastomer, or EP copolymer containing layer can frequently serve as a compatibilizing layer or portion thereof.

Another aspect of the present disclosure is that the interposed layers may be very thin, but due to their compatibility enhancement, the effect of the layer on the film properties is in no way diminutive. In this aspect, the dimensional contribution of the buffer layer may be small, but the consequence of compatibilizing the adjacent layers leads to a significant improvement in the properties of the overall film. As used in this sense, the term very thin may include layer thicknesses of less than 5 micron and less. In this respect, the interposed layer's thickness may contribute little to the total thickness of the film, but substantial to the film's overall properties.

As used herein, the term microcrystalline orientation refers to regular packing of polymer chains within a polymeric material. Polymers may be characterized as either crystalline or amorphous. Crystalline polymers include microcrystalline regions and amorphous polymers do not. As used herein, crystalline polymers include microcrystalline regions surrounded by amorphous regions. Microcrystalline regions may form in response to the intermolecular and intra-molecular hydrogen bonding and van der Waals attractive forces between the polymer chains. The crystallinity of a polymer refers to the extent of regular packing of molecular chains. Microcrystalline orientation refers to the alignment of the microcrystalline regions with respect to each other. Therefore, an oriented polymer is a crystalline polymer that has aligned microcrystalline regions.

The orientation exhibited by the microcrystalline regions can be further described. For example, microcrystalline regions can be aligned in row-nucleated microcrystalline orientations with non-twisted lamellae, row-nucleated microcrystalline orientations with twisted lamellae or spherulite-like microcrystalline orientations.

As used herein, a spherulite-like microcrystalline orientation includes spherical semi-crystalline regions characterized by plates of orthorhombic unit cells called crystalline lamellae. These ordered plates are dispersed amongst amorphous regions, wherein even a completely spherulized polymer is not fully crystalline. A spherulite-like microcrystalline orientation will exhibit birefringence due to its high degree of anisotropic order and crystallinity. The process of spherulization starts on a nucleation site and continues to extend radially outwards until a neighboring spherulite is reached. This explains the spherical shape of the spherulite. The presence of spherulites in a polymer changes the properties of the polymer with respect to crystallinity, density, tensile strength and modulus of elasticity. Specifically, each of these properties increases with increasing spherulite content.

The presence of polymers which do not tend to form spherulite-like microcrystalline orientations may inhibit the formation of crystal regions or cause alternative microcrystalline orientations to form. With this interference, the increase in density, tensile strength and modulus of elasticity may not be observed as one would expect with an increase in crystallinity. However, if a different microcrystalline orientation is provoked by the presence of these polymers, enhancements in properties associated with those microcrystalline orientations may be expected. For example, high pressure low density polyethylene having a highly branched structure is known to disrupt the formations of spherulite-like microcrystalline orientation in metallocene catalyzed polyethylene. Accordingly, a small percentage of the non-spherulite-forming polymer strongly influenced the properties of the composition.

As used herein, row-nucleated microcrystalline orientations include aligned crystalline lamellae, wherein the lamellae are either twisted or non-twisted. The lamellar arrangement is believed to originate from the high-molecular weight fraction of the polymer that orients into fibrils in the film extrusion direction (MD) during the film blowing or casting. These fibrils can act as nuclei for further crystallization. Since the lamellae grow perpendicular to the primary nuclei, orientation measurements in row-nucleated microcrystalline orientation films may show a preferential orientation in the direction perpendicular to MD.

As used herein, twisted lamellae morphology is when a row-nucleated microcrystalline orientation exhibits intertwined lamellae having an interlocked lamellar assembly instead of well-separated rows (non-twisted). The interlocking lamellae may include a boundary in which lamellae from different rows meet and are strongly connected or overlapped by the twisted growth. This orientation results in a strong increase in the MD Tear and MD tensile strength, but also results in a decrease in the TD Tear, TD tensile strength, and puncture resistance.

As used herein, the term strain hardening is an increase in hardness and strength caused by plastic deformation. Plastic deformation is a permanent change in shape. For example, irreversible stretching is a plastic deformation. Plastic deformation has the nanoscopic effect of increasing the material's entanglement density. As the material becomes increasingly saturated with new entanglements, a resistance to deformation develops. This resistance to deformation manifests itself as increased hardness and strength. This observed strengthening is referred to as strain hardening. In one aspect, strain hardening behavior in polymers is associated with the presence of long-chain branching or ultra high molecular weight chains in the polymer, such as those that may be found in a crosslinked polymer. Strain-hardening may be observed when a multi-layer film stretched. In a multi-layer stretch film, the presence of long-chain branching enables the film to exhibit a change in properties upon stretching. As used herein, the term strain is the deformation of a physical body under the action of applied forces. Specifically, deformation may be the elongation due to stretching and decrease in cross-sectional area associated therewith. In contrast to plastic deformation, a strain may be reversible.

As used herein, the term rapid molecular relaxation refers to an expedited rate by which polymer chains progress towards an equilibrium condition from a non-equilibrium condition. In illustrative embodiments, the non-equilibrium condition includes microcrystalline orientation and the equilibrium condition includes the absence of such microcrystalline orientation. In further embodiments, the non-equilibrium condition is an elevated entanglement density state and the equilibrium condition is a structure dependent normal entanglement density state. In yet another aspect, polymers having primarily short-chain branching exhibit rapid molecular relaxation due to short chains quickly relaxing. This may prevent an increase in the entanglement density. While polymers exhibiting short-chain branching may exhibit rapid molecular relaxation, it still may acquire a microcrystalline orientation, such as an elongated spherulite-like microcrystalline orientation. This orientation may exhibit increased tear resistance, but this behavior is distinct from the term strain hardening, as used herein.

One of ordinary skill in the art will appreciate that process conditions affect the molecular relaxation rates and the microcrystalline orientation. For example, the molecular relaxation rate is, at least partially, dependent on the temperature of the polymer and the rate at which the polymer molecules experience temperature changes. The effect of temperature and temperature change rates are controllable through process conditions. Additionally, the forces imparted by the manufacturing equipment during film formation strongly influence microcrystalline orientation. Blow up ratios, die gaps, production rates, and the like manifestly influence the microcrystalline structure. Accordingly the microcrystalline structure of a final product may be, in part, influenced by the process conditions.

One of ordinary skill in the art will appreciate that analytical techniques can be used to determine the microcrystalline orientation. For example, the microcrystalline orientation of film may be determined by, for example, birefringence or infrared spectroscopy (FTIR). Reference is made to Zhang et al. Polymer 45 (2004) 217-229, which is hereby incorporated by reference herein, for disclosure relating to microcrystalline orientation and the analysis thereof.

While not being limited to any particular theory, it is believed that the microscopic characteristics of the oriented film substantially contribute to the performance characteristics described herein. One aspect of the present disclosure is the incorporation of multiple layers of resins which each have distinct microcrystalline orientations into a single film to obtain a synergistic relationship which provides the final film with properties that are not achievable through use of any of the base resins or a blend of the base resins. In another aspect, it was discovered that resins containing both short and long chain branching, can be used in relatively small quantities to enhance the overall performance of a film. Another aspect of the present disclosure is that the properties of the polyethylene having both short and long chain branching, in particular, its solubility and crystallization behavior, were discovered to be greatly benefitted by the particular ordering of layers as described herein.

As used herein, a core is a multi-layer configuration of two or more layers of polyolefins or plastics. Furthermore, the term core is used when the multi-layer configuration does not include an exterior layer. As used herein, the term sheet is a planar arrangement of polyolefins or plastics which may or may not include multiple layers. The term sheet includes continuous planar arrangements, but is not limited to such arrangements. The term sheet also includes discontinuous planar arrangements, for example, meshes, porous sheets, perforated sheets, and scrims.

Melt Index. As used herein, melt index (MI) is a measure of the ease of flow of a polymeric composition. MI is equals the mass of polymer in grams flowing in 10 minutes through a capillary of specific diameter and length by an applied pressure. ASTM D-1238-00 refers to the standard test method for determining the melt index. MI is an indirect measure of molecular weight; a high melt index typically corresponds to low molecular weight. Furthermore, MI is a measure of the ability of the polymer composition to flow under pressure in its melted form. MI may be considered as inversely proportional to viscosity, but the viscosity is also dependent on the applied force.

Molecular Weight. Many analytical techniques are available for the determination of the MW and MWD. One such approach is described in ASTM D 4001-93 (2006) which refers to the standard test method for determination of weight-average molecular weight of polymers by light scattering. Gel permeation chromatography (GPC) can provide information on the MW as well as the MWD. Another technique which may be used to determine the properties of one or more of the polymer compositions described herein includes temperature rising elution fractionation (TREF). Furthermore, gel permeation chromatography (GPC) can be coupled with TREF to obtain other properties of a particular polymeric composition.

Density. Density values refer to those obtained according to ASTM D 1505-98, which is the standard test method for density of plastics by the density-gradient technique.

Branching. The extent to which a polymer is branched and the length of those branches may be determined by, for example, C-13 NMR, GPC, temperature rising elution fractionation (TREF), and Crystallization analysis fractionation (Crystaf). Furthermore, rheological properties may be used to compare relative amounts of short and long chain branching. For example, relaxation time reflects the time taken for the polymer chains to relax after deformation in a molten condition. Another way to analyze the branching is through linear thermal shrinkage. A polymer in the form of a film or sheeting may be tested according to ASTM D 2732-96. ASTM D 2732 refers to the standard test method for unrestrained linear thermal shrinkage. Unrestrained linear thermal shrinkage, otherwise known as free shrink, refers to the irreversible and rapid reduction in linear dimension in a specified direction occurring in film subjected to elevated temperatures under conditions where nil or negligible restraint to inhibit shrinkage is present. As used herein, it will be expressed as a percentage of the original dimension.

Short chain branching (SCB), as used herein, is branching of less than approximately 40 carbon atoms. One aspect of the present disclosure is the SCB may interfere with the formation of the microcrystalline structures. As used herein, long chain branching (LCB) is branching with lengths longer than the average critical entanglement distance of a linear polymer chain. For example, long chain branching includes branching with chain lengths greater than 40 carbon atoms. Another aspect of the present disclosure is that a substantially linear polyethylene includes substantial SCB but substantially no LCB. Accordingly, substantially linear polyethylene may be referred to as substantially short chain branched polyethylene.

As used herein, substantially no long chain branching is defined as a LCB density of less than about 0.01 long chain branch points per 1000 main chain carbons. As used herein, some long chain branching is defined as a LCB density of about 0.01 to about 0.2 long chain branch points per 1000 main chain carbons. As used herein, substantial long chain branching is used to describe polymers having greater than 0.2 long chain branch points per 1000 main chain carbons.

Tear resistance. As used herein, ASTM D 1922-00 refers to the standard test method for propagation tear resistance of plastic film and thin sheeting by pendulum method. The values obtained through the testing methods described by this ASTM standard method are also referred to as Elmendorf values. The Elmendorf values are the force in grams required to propagate tearing across a film or sheeting specimen. Transverse direction tear resistance (TD Tear) and machine direction tear resistance (MD Tear) are defined according to the ASTM standard.

Puncture Resistance. Puncture resistance is a measure of the energy-absorbing ability of a film in resisting a protrusion, i.e. breaking the continuity of a film. It is considered to be an indicator of the end-use performance of a stretch wrap film within the scope of its regular application. One manner of evaluating puncture resistance is determining the energy that causes the film to fail upon the impact of a free-falling dart. ASTM D 1709-98 can be used to determine this type of puncture resistance. Under specified conditions, this test is also known as the F-50 dart drop test. Another well known puncture resistance test is ASTM D 5748-95 (2007). This test method provides a means of measuring a films' puncture resistance under essentially biaxial deformation conditions.

Tensile Testing. In an evaluation of the properties of a polyolefinic film, tensile testing may be performed. Tensile testing involves elongating a specimen and measuring the load carried by the specimen. The dimensions of the specimen and the change in those dimensions upon carrying the load may be used with the load and deflection data to construct a stress-strain curve. Tensile properties can be extracted from the stress-strain curve according to ASTM D 882-00. As used herein, ASTM D 882-00 refers to the standard test method for tensile properties of thin plastic sheeting. Tensile strength is the maximum load divided by the original minimum cross-sectional area of the specimen and differs depending on whether measured in the machine direction or transverse direction. Percent elongation at break, also known as ultimate elongation, may be calculated by dividing the extension at the moment of rupture of the specimen by the initial gage length of the specimen and multiplying by 100.

ASTM standard test methods incorporated by reference. Reference is made to each ASTM standard test methods described herein, which ASTM standard test methods are hereby incorporated by reference herein, for disclosure relating to the methods for testing polymeric compositions and films made thereof.

Analytical Limitations. Another aspect of the present disclosure is that adjacent layers and sheets may be comprised of compositions which are substantially indistinguishable through analytical techniques. This aspect of the present disclosure results in multi-layer stretch films which may have more layers than analytically perceivable. In one aspect, the decoupling strategy may involve introducing layers adjacent to each other which have very similar chemical and/or physical properties. The similarity of chemical and/or physical properties between the layers combined with the diminutive layer thickness may result in the number of layers perceived through analytical techniques being lower than the actual number of layers present.

cPE. As used herein, the term catalyzed polyethylene (cPE) is used generally to describe a copolymer of ethylene and an alpha olefin comonomer made through a catalyzed reaction (e.g., through a Ziegler-Natta, Philips, metallocene, or other single site catalyzed reactions). cPE includes polymers made through non-metallocene or “post-metallocene” catalyzed reactions resulting in a copolymer of ethylene and an alpha olefin copolymer. cPE includes copolymers made with various alpha olefin monomers including 1-butene, 3-methyl-1-butene, 3-methyl-1-pentene, 1-hexene, 4-methyl-1-pentene, 3-methyl-1-hexene, 1-octene or 1-decene. In one embodiment, the cPE is a copolymer of ethylene and one selected from the group of 1-hexene and 1-octene. In another embodiment, the cPE is a copolymer of ethylene and 1-octene.

In illustrative embodiments, cPE has a MWD within the range of about 1 to about 6. In one embodiment, cPE has a MWD within the range of about 1.5 to about 5. In another embodiment, cPE has a MWD within the range of about 2 to about 4. In illustrative embodiments, the cPE has an average molecular weight from about 20,000 to about 500,000 g/mol, preferably from about 50,000 to about 200,000 g/mol.

ZN PE. In illustrative embodiments, the term cPE includes a Ziegler-Natta catalyzed polyethylene (ZN PE). In one aspect, a Ziegler-Natta may be referred to as heterogeneous catalyst since it may be composed of many types of catalytic species each at different metal oxidation states and different coordination environments with ligands. Examples of Ziegler-Natta heterogeneous catalytic systems include metal halides activated by an organometallic co-catalyst, such as titanium or magnesium chlorides complexed to trialkyl aluminum and may be found in patents such as U.S. Pat. Nos. 4,302,565 and 4,302,566. Because these systems contain more than one catalytic species, they possess polymerization sites with different activities and varying abilities to incorporate comonomer into a polymer chain.

Accordingly, one characteristic of a ZN PE is that it includes products having diverse polymer chain architectures within one polymeric molecule. For example, one portion of the polymer may contain high comonomer content while another portion contains very little. Furthermore, there may be substantial diversity in architecture between two different polymer molecules within a given population. For example, some molecules may be very large with extensive comonomer incorporation while other molecules may be relatively small with very little comonomer incorporation. Another characteristic is that the differences in catalyst efficiency produce high molecular weight polymer at some sites and low molecular weight polymers at other sites. Therefore, ZN PE includes polymeric products which are mixtures of molecules, wherein, some molecules have high comonomer content and other molecules have almost no comonomer content.

For example, conventional Ziegler-Natta multi-site catalysts may yield a linear ethylene/alpha-olefin copolymer having a mean comonomer percentage of 10%, but with a range of about 1% to about 40% comonomer in individual molecules. Accordingly, this, together with the diversity of chain lengths results in a truly heterogeneous mixture also having a broad molecular weight distribution (MWD). In illustrative embodiments, ZN PE has a MWD within the range of about 3 to about 5. In one embodiment, ZN PE has a MWD of about 4.

In illustrative embodiments, the film comprises a ZN PE having a MI of about 1 to about 6 g/10 min. In one embodiment, the film comprises a ZN PE having a MI of about 3 to about 4 g/10 min. In illustrative embodiments, the film comprises a ZN PE having a density of about 0.91 to about 0.94 g/cm³. In one embodiment, the film comprises a ZN PE having a density of about 0.92 to about 0.93 g/cm³. In another embodiment, the film comprises a ZN PE having a density of about 0.92 g/cm³.

mPE. The term mPE includes polyethylenes polymerized utilizing a metallocene, post-metallocene, or other single site catalyzed reaction. A mPE is a type of cPE. In one aspect, mPE is manufactured using a catalytic system, wherein each catalytic position has steric and electronic equivalence. Accordingly, the catalytic system is characterized as having a single, stable chemical type rather than a mixture of states, as may be found in a Ziegler-Natta catalyst system. The uniformity or equivalence in catalytic sites results in a singular activity and selectivity. The catalyst used to make mPE includes an organometallic compound and one or more cyclopentadienyl ligands attached to metals such as hafnium, titanium, vanadium, or zirconium. Furthermore, a co-catalyst, such as but not limited to, oligomeric methyl alumoxane may be used to promote the catalytic activity. The mPE can be catalyzed with a variety of ligands complexing a variety of metals which will be well known to one of ordinary skill in the art.

One characteristic of an mPE is that the molecules are uniform in chain length and in average comonomer content. Furthermore, the molecules may be characterized by a regularity of comonomer spacing along the length of the molecule. Accordingly, molecules within a population of mPE all have nearly equivalent molecular structure. The equivalence in molecular structure can be appreciated according to the characteristically narrow molecular weight distribution (MWD) that mPE exhibits. For example, a mPE may have a MWD from about 1.5 to about 2.5. For example, a mPE may have a MWD of about 2.

Another property of mPE is its melting point range. The narrow composition distribution of mPE results in mPE exhibiting a narrow melting point range as well as a lower Differential Scanning Calorimeter (DSC) peak melting point peak. In one aspect, an mPE exhibits a melting point which is directly related to density. For example, an mPE comprising ethylene and butene having a density of 0.905 g/cm³ may have a peak melting point of about 100° C. However, a slightly lower density ethylene and butene copolymer which was made using a ZN catalyst may have a melting point at about 120° C. DSC shows that a ZN PE resin exhibits a much wider melting point range with a higher melting point despite its lower density.

In illustrative embodiments, the alpha olefin comonomer is selected from the group consisting of butene, hexene, and octene. The alpha olefin comonomer may be incorporated from about 1% to about 20% by weight of the total weight of the polymer, preferably from about 1% to about 10% by weight of the total weight of the polymer. In one embodiment the alpha olefin comonomer is incorporated at a percentage of from about 6% to about 8%. In one embodiment, the alpha-olefin is butene incorporated at a percentage of between about 5% to about 15%. In another embodiment, the alpha-olefin is butene incorporated at a percentage of between about 5% to about 15%.

In illustrative embodiments, the film comprises a mPE having a MI of about 1 to about 6 g/10 min. In one embodiment, the film comprises a mPE having a MI of about 3 to about 4 g/10 min. In illustrative embodiments, the film comprises a mPE having a density of about 0.91 to about 0.94 g/cm³. In one embodiment, the film comprises a mPE having a density of about 0.92 to about 0.93 g/cm³. In another embodiment, the film comprises a mPE having a density of about 0.92 g/cm³.

Furthermore, exemplary means of manufacturing mPE include both solution phase or gas phase reactors. Reference may be made to U.S. Pat. Nos. 3,645,992; 4,011,382; 4,205,021; 4,302,566; 6,184,170; 6,919,467; U.S. Publ. Nos. 2008/0039606; and 2008/0045663 for examples of resins which may be particularly useful herein. One aspect of a mPE is that it comprises a polymer chain having primarily short-chain branching (SCB). mPE can be described as a substantially linear polyethylene because the molecular structure is dominated by SCB and lacking substantial long-chain branching.

The microcrystalline orientation of a polymer composition made entirely of polyethylene exhibiting primarily SCB, when used within the scope of the materials and processes described herein, can be described as having a spherulite-like microcrystalline orientation.

Diversely Branched PE (DB PE). As used herein, the term diversely branched polyethylene (DB PE) includes a polyethylene resin having a homogeneous molecular weight distribution with at least some short chain branching and at least some long chain branching. In contrast to ZN PE, the molecular weight distribution of DB PE is substantially equivalent to mPE. However, the presence of at least some LCB, distinguishes DB PE from a mPE, as described herein. While distinguished from the term mPE, as used herein, a DB PE may be manufactured using a metallocene type catalyst. For example, resins included within the scope of the term DB PE include those resins manufactured by Dow Chemical, Midland Mich., under the trademark ENABLE. DB PE may have a density of from about 0.92 to about 0.93 g/cm³ and a MI of from about 0.3 to about 1 g/10 min. In illustrative embodiments, DB PE has a MWD within the range of about 1 to about 5. In one embodiment, DB PE has a MWD of about 2.5.

One aspect of the present disclosure is that use of DB PE in one or more layers, as described herein, contributes to the film having unexpectedly enhanced film properties. For example, a diversely branched polyethylene provides enhanced compatibility between adjacent layers. In particular, a very thin layer of a diversely branched layer, alone or in a blend with another cPE or a LDPE enhances the compatibility between layers. Accordingly, a diversely branched polyethylene may be particularly useful within a compatibilizing layer or a buffer layer. In particular, a diversely branched polyethylene may be used as a buffer layer between layers that would ordinarily exhibit poor compatibility when adjacently arranged.

In illustrative embodiments, the multi-layer shrink film includes at least one layer comprised of a polyethylene exhibiting substantial short and long chain branching. In one aspect of the present disclosure, polyethylene exhibiting substantial short and long chain branching may not pack into the crystal structures well. Therefore, polyethylene exhibiting substantial short and long chain branching may have a tendency to form amorphous structures. Accordingly, the intermolecular forces are weaker and the instantaneous-dipole induced-dipole attraction may be lower. Furthermore, polyethylene exhibiting substantial short and long chain branching has a lower tensile strength than more crystalline polyethylene but comparably greater ductility.

VLDPE. As used herein, VLDPE is a cPE having a density of about 0.88 to about 0.92 g/cm³ or from about 0.89 g/cm³ to about 0.91 g/cm³. It may be referred to as ultra low density polyethylene (ULDPE) or very low density polyethylene (VLDPE). VLDPE may have a MI of from about 0.5 to about 5 g/10 min, preferably from about 1 to about 4 g/10 min. For example, a VLDPE may have a density of about 0.91 g/cm³ and a MI of about 3 g/10 min. Similarly, a VLDPE may have a density of about 0.90 g/cm³ and a MI of about 4 g/10 min. A VLDPE having a density from about 0.90 to about 0.91 g/cm³ and a MI of about 1 g/10 min may also be used. In one aspect, the characteristic density may have been achieved by copolymerizing ethylene with one of 1-butene, 1-hexene, 4-methyl-1-pentene, or 1-octene. In one embodiment, the VLDPE is a copolymer of ethylene and one comonomer selected from the group of 1-hexene and 1-octene. In another embodiment, the cPE is a VLDPE being a copolymer of ethylene and 1-octene, wherein copolymer has a mean comonomer percentage of about 10%.

LDPE. As used herein, low density polyethylene (LDPE) is defined as a polyethylene polymer with a density in the range of about 0.91 g/cm³ to about 0.93 g/cm³. LDPE may be polymerized through a free radical polymerization and has a high degree of short and long chain branching. The term LDPE is intended to include high pressure low density polyethylene (HPLDPE) polymerized through a high pressure free radical polymerization. For example, LDPE may be an ethylene homopolymer made using a free radical initiator at pressures from about 15,000 psi to about 50,000 psi and at temperature up to about 300° C. in a tubular or stirred reactor. According to this polymerization technique, numerous long chain branches may be formed along the length of the polymer. In one aspect, the LDPE may be characterized as having a single low melting point. For example, a 0.92 g/cm³ density LDPE would typically have a melting point at about 112° C. In another aspect, LDPE may not pack into the crystal structures well. Therefore, LDPE may have a tendency to form amorphous solid structures. Accordingly, the intermolecular forces are weaker and the instantaneous-dipole induced-dipole attraction may be lower. Furthermore, LDPE has a lower tensile strength than HDPE but comparably greater ductility.

In illustrative embodiments, the film comprises LDPE having a MI of about 0.1 to about 20 g/10 min. In one embodiment, the film comprises LDPE having a MI of about 2 g/10 min. In another embodiment, the film comprises LDPE having a MI of about 0.2 g/10 min. In illustrative embodiments, the film comprises LDPE having a density of about 0.91 g/cm³ to about 0.93 g/cm³. In another embodiment, the film comprises LDPE having a density of about 0.92 g/cm³.

HDPE. In illustrative embodiments, the multi-layer film includes at a layer comprised of high density polyethylene. In another embodiment, the high density polyethylene is a product of reacting ethylene by a means to form a product exhibiting very little short chain or long chain branching so that the polyethylene has a highly crystalline structure.

In illustrative embodiments, the high density polyethylene is a homo-polymeric high density polyethylene with a mono-modal MWD. The homo-polymeric high density polyethylene is a product of reacting ethylene such that the product has substantially no branching. In one embodiment, the homo-polymeric high density polyethylene has a MI of about 1 g/10 min to about 9 g/10 min and a density of about 0.935 g/cm³ to about 0.96 g/cm³.

EAC. As used herein, the term ethylene acrylate copolymers (EAC) include polymers with various molecular weights, densities, and tacticities synthesized from ethylene and acrylate monomers. Included within the scope of this disclosure are copolymers such as ethylene methyl acrylate (EMA), ethylene ethyl acrylate (EEA), ethylene butyl acrylate (EBA) and ethylene vinyl acetate (EVA). In one embodiment, the EAC are random copolymers. In another embodiment, the EAC is a block copolymer. In yet another embodiment, the EAC is phase separated, that is, the copolymer is polymerized in a manner such that the blocks are immiscible. Accordingly, the EAC of the present disclosure includes polymers that have ordered microstructures. Also included within the scope of this disclosure are EAC polymers exhibiting ordered morphologies such as spheres, cylinders, and lamellae, ordered bicontinuous double-diamond, ordered tricontinuous double-diamond or perforated-lamellar morphologies.

In illustrative embodiments, the film includes an ethylene-vinyl acetate (EVA) copolymer containing substantial long chain branching. In one embodiment, the EVA is the type that is made using a high pressure process. For example, the EVA may be manufactured through a free radical polymerization reaction between ethylene and vinyl acetate. In one embodiment, this polymerization may be performed in conventional stirred autoclave or tubular reactors at high pressure (in this context, greater than about 20,000 psi) and at high temperatures (in this context, from about 200-320° C.). In another embodiment, the molecular weight of the EVA copolymers is controlled by the addition of chain terminators, such as propylene or isobutylene. In another embodiment, the type and level of branching of an EVA copolymer may be similar to that observed in LDPE. In another embodiment, from about 5 to about 50 weight percent (based on the total weight of the final EVA copolymer) vinyl acetate is copolymerized with ethylene. In yet another embodiment, the EVA copolymers have vinyl acetate content from about 2% to about 9%, based on the total weight of the final EVA copolymer. In one embodiment, EVA copolymer comprises from about 5% to about 15% by weight copolymerized vinyl acetate and has a density from about 0.88 g/cm³ to 0.912 g/cm³ and melt indexes from about 0.5 to 10 g/10 min.

In illustrative embodiments, the film comprises EAC having a MI of about 0.1 to about 20 g/10 min. In one embodiment, the film comprises EAC having a MI of about 0.5 to about 8 g/10 min. In one embodiment, the film comprises EAC having a MI of about 0.5 to about 0.8 g/10 min. In another embodiment, the film comprises EAC having a MI of about 0.65 g/10 min. In illustrative embodiments, the film comprises EAC having a density of about 0.91 g/cm³ to about 0.93 g/cm³. In one embodiment, the film comprises EAC having a density of about 0.920 g/cm³ to about 0.925 g/cm³. In another embodiment, the film comprises EAC having a density of about 0.92 g/cm³. In another embodiment, the EAC has a density of about 0.945 g/cm³, a MI of about 10.0 g/10 m and contains about 24% of methyl acrylate co-monomer.

In illustrative embodiments, the film includes at least one layer containing an EMA copolymer. In one embodiment, the EMA copolymer has a MI from about 3 to about 7. In another embodiment, the EMA copolymer has a density in the range of about 0.93 g/cm³ to about 0.96 g/cm³. In one embodiment, the EMA copolymer includes about 15% to about 35% methyl acrylate units and from about 65% to about 85% ethylene units. In one embodiment, the EMA copolymer includes about 24% methyl acrylate units and about 76% ethylene units.

EP copolymer. As used herein, the term ethylene propylene copolymer (EP copolymer) includes polymers with various molecular weights, densities, and tacticities synthesized from ethylene and propylene monomers in various ratios. For example, the term EP copolymer includes polymers comprised predominantly of ethylene units and polymers predominantly of propylene units. For example, EP copolymers within the scope of this disclosure may include from about 1% to about 99% ethylene monomer units and from about 1% to about 99% propylene monomer units.

In illustrative embodiments, the film comprises EP copolymer having a MI of about 0.1 to about 20 g/10 min. In one embodiment, the film comprises EP copolymer having a MI of about 4 to about 14 g/10 min. In one embodiment, the film comprises EP copolymer having a MI of about 6 to about 8 g/10 min. In illustrative embodiments, the film comprises EP copolymer having a density of about 0.88 g/cm³ to about 0.92 g/cm³. In one embodiment, the film comprises EP copolymer having a density of about 0.89 g/cm³ to about 0.91 g/cm³. In another embodiment, the film comprises EP copolymer having a density of about 0.900 g/cm³ to about 0.902 g/cm³. In illustrative embodiments, the film comprises EP copolymers comprising a random copolymer structure with from about 0.1% to about 8% ethylene. In one embodiment, the EP copolymer comprises from about 3% to about 5% ethylene in a random copolymer structure.

PP. As used herein, the term polypropylene (PP) includes polymers with various molecular weights, densities, and tacticities synthesized from propylene monomers. The term PP is intended to include polymers which are homopolymers of propylene or copolymers of propylene or other lower or higher alpha olefins, such as ethylene. The term PP, within the scope of this disclosure, includes PP characterized as soft PP. In illustrative embodiments, the PP is a polypropylene homopolymer has a density of about 0.9 g/cm³, and an MI of about 12 g/10 min.

Elastomer. As used herein, the term elastomer is defined as an elastic polymer or copolymer that can reversibly extend in the range from about 5% and about 700%. Elastomers comprising ethylene and propylene may additionally be referred to as EP elastomers. In one embodiment, the elastomer is a copolymer of propylene and ethylene comprising about 12% to about 16% ethylene by weight and 84% to about 88% propylene. The term elastomer is also intended to include very low density elastomers. As used herein, the elastomer is copolymer having a MI from about 3 g/10 min to about 18 g/10 min and a density from about 0.85 g/cm³ to about 0.88 g/cm³. In one embodiment, the elastomer has an MI of about 8 g/10 min and a density of about 0.86 g/cm³.

Plastomer. As used herein, the term plastomer is defined as a polymer having a broad crystallinity distribution which results in a broad melting behavior. The narrow molecular weight distribution and broad crystallinity distribution result in improved temperature performance compared to metallocene catalyst-based products of comparable olefin content. The broad crystallinity distribution results in broad melting behavior; a high melting shoulder is maintained even as the overall crystallinity of the polymer decreases. It is the combination of these factors that we believe delivers the range of application benefits. In illustrative embodiments, a plastomer has a MI from about 2 g/10 min to about 4 g/10 min and a density from about 0.86 g/cm³ to about 0.9 g/cm³. In another embodiment, the plastomer has an MI of about 3 g/10 min and a density of about 0.88 g/cm³. In yet another embodiment, the elastomer has an MI of about 8 g/10 min and a density of about 0.86 g/cm³.

In illustrative embodiments, the plastomer has a molecular weight distribution (MWD) from about 2 to about 3. In one embodiment, the MI of the plastomer is from about 2 g/10 min to about 25 g/10 min. In another embodiment a plastomer is a polyolefin comprising an ethylene-octene copolymer having a MI from about 2 g/10 min to about 4 g/10 min, a density from about 0.86 g/cm³ to about 0.9 g/cm³. In one embodiment, the plastomer has an MI of about 3 g/10 min and a density of about 0.88 g/cm³.

PIB. In illustrative embodiments, one or more layers may include a poly-isobutylenes (PIB). According to one embodiment, the PIB may have been produced by polymerization of about 98% of isobutylene with about 2% of isoprene. According to another embodiment, the PIB may have been produced by polymerization of 2-methyl-1-propene. In illustrative embodiment, the PIB may have a number average molecular weight in the range from about 1,000-3,000 g/mol as measured by vapor phase osmometry. In another embodiment, the PIB may have a number average molecular weight in the range from about 1200-1800 g/mol as measured by vapor phase osmometry.

SBC. As used herein, the term styrenic block copolymer (SBC) includes polymers having styrene polymerized with at least one copolymer in a manner such that a block copolymer results. One of ordinary skill in the art will appreciate that a block copolymer is substantially different than a random copolymer due to the blocked molecular structure. Within the scope of block copolymer are copolymers of styrene with one of or a combination of butadiene, butylene, ethylene, isoprene. One aspect of a SBC polymer is that it may exhibit micro- or nano-scale phase separation. For example, an SBC may form a periodic nanostructures. One aspect of the present disclosure is that the periodic nanostructure results in improved cling properties in a particular layer. In another aspect of the present disclosure, the periodic nanostructure may be used in a buffer layer to provide greater compatibility between the layers between which the buffer layer is interposed. In yet another aspect, a blend of SBC with a cPE may similarly serve as a compatibilizing layer. In one embodiment, SBC has a density of about 0.9 g/cm³, and a MI of from about 2 g/10 min and about 25 g/10 min.

While not being limited to a particular theory, the polymers herein may be blended in various ratios to obtain a polymeric blend having the desired properties for a given layer. The polymer blends may be formed by any convenient method, including dry blending the individual components and subsequently melt mixing, either directly in the extruder used to make the film, or by pre-melt mixing in separate extruder before making the film. The polymer blends may also be prepared by dual polymerization techniques, or by melt conveying the desired amount of a first polymer directly into a molten stream of second polymer from a polymerization reactor, prior to pelletization of the polymer blend. The polymer blends can also be made by dry blending discrete polymers having the specified properties in appropriate weight ratios, as described herein.

In illustrative embodiment, one or more layers may include a blend of a cPE and a LDPE. Reference is made to U.S. Pat. No. 7,172,815, which is hereby incorporated by reference herein, for disclosure relating to blends of cPE and LDPE. In one embodiment, a blend comprising LDPE and cPE includes LDPE as a minor component. In one aspect, the proportion of cPE:LDPE in the polymer blend is dependent upon the molecular weight of the LDPE. In one embodiment, the cPE:LDPE ratio is from about 5:1 to about 33:1. In another embodiment, the cPE:LDPE ratio is from about 7:1 to about 25:1. For a LDPE with a MI from about 0.1 to about 1 g/10 min, the cPE:LDPE ratio is from about 16:1 to about 33:1. In one embodiment, for a LDPE having a MI of greater than about 1 g/10 min to about 2 g/10 min, the cPE:LDPE ratio is from about 7:1 to about 24:1. In another embodiment, for a LDPE having a MI of greater than about 1 g/10 min to about 2 g/10 min, the cPE:LDPE ratio is from about 7:1 to about 16:1. In one embodiment, for a LDPE having a MI of greater than about 2 g/10 min to about 20 g/10 min, the cPE:LDPE ratio is from about 4.5:1 to about 16:1. In another embodiment, for a LDPE having a MI of greater than about 2 g/10 min to about 20 g/10 min, the cPE:LDPE ratio is from about 4.5:1 to about 7.5:1.

In illustrative embodiments, octene or hexene mPE having a MI from about 2 g/10 min to about 5 g/10 min and a density from about 0.910 g/cm³ to about 0.925 g/cm³ may be blended with LDPE having a MI from about 0.25 g/10 min to about 2 g/10 min and a density from about 0.918 g/cm³ to about 0.924 g/cm³. The LDPE may be blended in at a percentage from about 1% to about 5% by total weight.

According to one aspect, LDPE having lower MI resins may have more of an influence on the orientation effect of mPE than do resins having MI of about 2 g/10 min. Another aspect is that LDPE blended in mPE may begin to have a negative effect on film puncture properties at blends above 5%. As disclosed herein, LDPE has high long-chain branching and accordingly may increase the MD orientation of a mPE such that the TD Tear is improved. In another aspect, mPE has a very fast relaxation time that inhibits orientation unless blended with other resins. Other LCB resins may exhibit a similar improvement in TD Tear in a blend with mPE, for example, a DB PE. In illustrative embodiments, a blend comprising about 80% mPE and about 20% DB PE may exhibit orientation similar to a blend of mPE and LDPE.

In illustrative embodiments, a cling layer comprises a polymer blend. In one embodiment, the cling layer comprises about 60% to about 90% mPE and about 10% to about 40% plastomer. In another embodiment, the cling layer comprises about 90% mPE and about 10% plastomer. Illustratively, the mPE may be a hexene mPE having a MI of about 3.2 g/10 min and a density of about 0.918 g/cm³. The plastomer may have a MI of about 3.0 g/10 min and a density of about 0.875 g/cm³. In another embodiment, the mPE may comprise about 80% of the blend and have a MI of about 3.5 g/10 min and a density of about 0.918 g/cm³. The plastomer may comprise about 20% of the blend and have a MI of about 3.0 g/10 min and a density of about 0.875 g/cm³. In yet another embodiment, the blend may comprise about 80% mPE having a MI of about 18 g/10 min and a density of about 0.861 g/cm³.

In illustrative embodiments, a non-cling layer comprises a polymer blend. In one embodiment, the non-cling layer comprises about 60% to about 90% mPE and about 10% to about 40% mPE having a medium density. In another embodiment, the non-cling layer comprises about 70% mPE and about 30% mPE having a medium density. Illustratively, the first mPE may have a MI of about 3.5 g/10 min and a density of about 0.918 g/cm³. The mPE having a medium density may have a MI of about 3.5 g/10 min and a density of about 0.927 g/cm³. In illustrative embodiments, the mPE having a medium density may have an MI from about embodiment, the first mPE may comprise about 80% of the blend and have a density from about 0.928 g/cm³ to about 0.940 g/cm³ and an MI from about 2 g/10 min to about 4 g/10 min.

In one aspect of the present disclosure, the puncture resistance properties of the multi-layer stretch film are substantially decoupled from the other properties mentioned herein. For example, puncture resistance and the ratio of MD Tear and TD Tear are typically considered coupled. For example, an increase in puncture resistance is typically coupled to a specific MD Tear to TD Tear ratio. Another example is that puncture resistance and ultimate elongation are typically considered coupled. For instance, an increase in puncture resistance is typically considered to be coupled with a decrease in ultimate elongation. One aspect of the present disclosure is that puncture resistance performance is decoupled from TD Tear and ultimate elongation performance. The product and process of the present disclosure consists or result in a multi-layer stretch film with unexpectedly elevated puncture resistance without sacrificing TD Tear or ultimate elongation performance.

In one aspect of the present disclosure, the stress level properties of the multi-layer stretch film are decoupled from the other properties mentioned herein. As previously mentioned, one aspect of the present disclosure is that TD Tear is decoupled from puncture resistance. Typically, puncture resistance is coupled to stress level in that low stress films typically have higher puncture resistance and high stress films typically have lower puncture resistance. The multi-layer stretch films of the present disclosure have unexpectedly high stress level, but do not necessarily possess a depressed puncture resistance.

As discussed herein, one aspect of the present disclosure is that the tear resistance properties of the multi-layer stretch film are decoupled from the other properties mentioned herein. As mentioned herein, one aspect of the present disclosure is that TD Tear is substantially decoupled from puncture resistance. Typically, puncture resistance is coupled to the ratio of the TD Tear to MD Tear. A stretch film will typically have the best puncture resistance when the TD Tear to MD Tear ratio of approximately 1:1. An aspect of the present disclosure is a product and process that decouples puncture resistance from the absolute value of the TD Tear or the MD Tear. One aspect of the present disclosure is that the TD Tear to MD Tear ratio can be maintained at a 1:1 ratio while the puncture resistance is significantly increased.

In particular, the stretch wrap films are constructed such that the overall TD Tear, is at least about 500 g/mil, preferably at least about 550 g/mil, more preferably at least about 600 g/mil. The MD Tear of the film is generally at least about 125 g/mil, preferably at least about 150 g/mil, and more preferably at least about 175 g/mil. However, the present disclosure describes a material and process with elevated puncture resistance which is not dependent on the TD Tear to MD Tear ratio. While those ratios may still afford the best puncture resistance, the multi-layer stretch films of the present disclosure do not necessarily have to maintain this range of ratios to still have elevated puncture resistance. The present disclosure provides a product and process with enhanced tear resistance without sacrificing other performance characteristics.

In illustrative embodiments, the puncture resistance is decoupled from TD Tear and ultimate elongation through the incorporation of the multiple layers as disclosed herein. For example, the F-50 dart drop of the multi-layer stretch film is at least about 130 g/mil, preferably at least about 150 g/mil, and more preferably from at least about 170 g/mil.

In another embodiment, a higher puncture resistance may be of interest. For example, in one embodiment the F-50 dart drop of the multi-layer stretch film may be at least about 900 g/mil, preferably at least about 1000 g/mil, and more preferably from at least about 1200 g/mil. The present disclosure provides a product and process with enhanced puncture resistance without sacrificing other performance characteristics.

The films of the present disclosure generally have a stress level at 200% elongation of at least about 1400 psi., preferably at least about 1450 psi., and more preferably at least about 1500 psi. The films of the present disclosure generally have a stress level at 250% elongation of at least about 1500 psi., preferably at least about 1550 psi., and more preferably at least about 1600 psi.

In illustrative embodiments, the multi-layer film includes at least one layer which strongly exhibits a spherulite-like microcrystalline orientation. In another embodiment, the multi-layer film includes at least one layer in which the spherulite-like microcrystalline orientation is substantially inhibited by the presence of a small amount of polymer which does not nucleate to form a spherulite-like microcrystalline orientation. In particular, the incorporation of a small amount of a polymer with long-chain branching may prevent rapid molecular relaxation. Therefore, the microcrystalline structure of the polymeric blend remains during cooling. The microcrystalline structure then imparts the polymeric blend with properties less like that of an elongated spherulite-like polymer and more like a row-nucleated structure.

In illustrative embodiments, a multi-layer film comprises a cling layer, a non-cling layer, a first interior layer, a second interior layer, the second interior layer being incompatible with the first interior layer, and a compatibilizing layer interposed between the first interior layer and the second in layer. In one embodiment, the film has a TD tear of 450 g, a F-50 dart drop puncture resistance of 1000 g, and a thickness of less than or equal to about 41 gauge. In another embodiment, the film has a thickness of about 36 to about 40 gauge. In another embodiment, the film has a thickness of less than or equal to about 39 gauge. Illustratively, the film's structure provides the film with decoupled attributes which were previously possible only in thicker films.

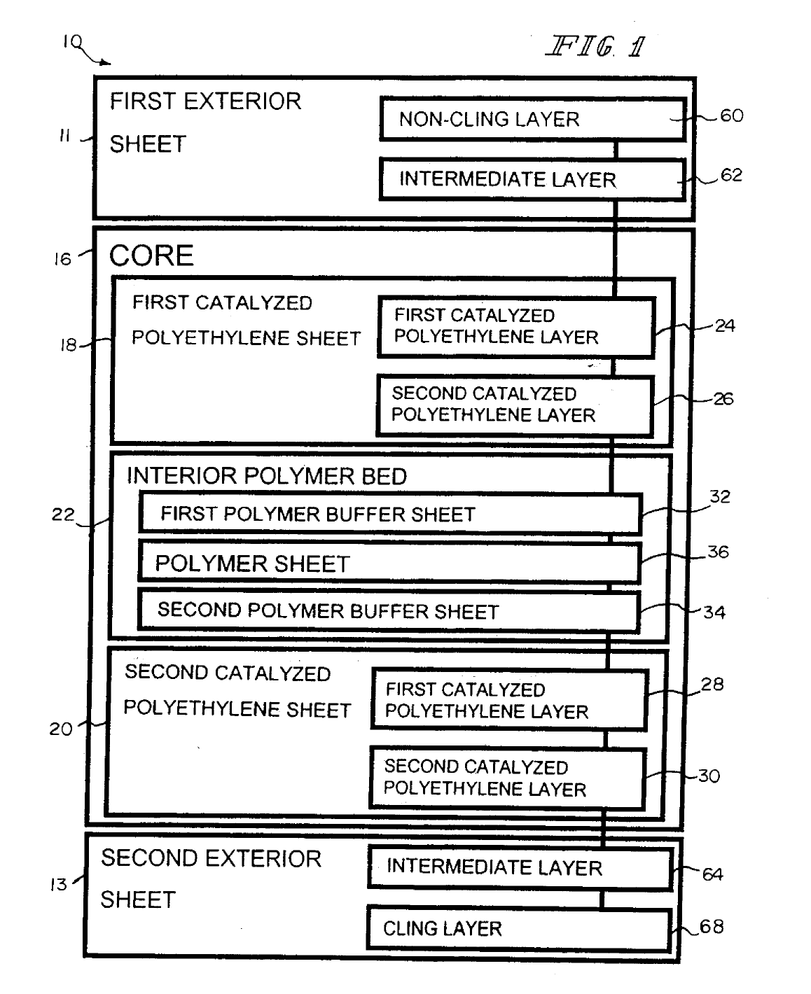

Referring now to FIG. 1, a multi-layer stretch film 10 comprises a first exterior sheet 11, a second exterior sheet 13, and a core 16 interposed and arranged to contact the first and second exterior sheets. Core 16 comprises an interior polymer bed 22 interposed and arranged to contact a first catalyzed polyethylene sheet 18 and a second catalyzed polyethylene sheet 20. Interior polymer bed 22 comprises a first polymer buffer sheet 32, a second polymer buffer sheet 34 and a polymer sheet 36, interposed and arranged to contact first polymer buffer sheet 32 and second polymer buffer sheet 34. First exterior sheet 11 comprises a non-cling layer 60 and an intermediate layer 62. Second exterior sheet 13 comprises a cling layer 68 and an intermediate layer 64. First catalyzed polyethylene sheet 18 comprises a first catalyzed polyethylene layer 24 and a second catalyzed polyethylene layer 26. Second catalyzed polyethylene sheet 20 comprises a first catalyzed polyethylene layer 28 and a second catalyzed polyethylene layer 30.

First exterior sheet 11. First exterior sheet 11 comprises non-cling layer 60 and intermediate layer 62. In illustrative embodiments, non-cling layer 60 has a non-cling or a low-cling property. In one embodiment, non-cling layer 60 comprises a polymer composition providing an exterior surface of the first exterior sheet with a low coefficient of friction. For example, a coefficient of friction of less than about 0.9. In one embodiment, the coefficient of friction of non-cling layer 60 is about 0.5.

In one embodiment, non-cling layer 60 comprises cPE. In another embodiment, non-cling layer 60 comprises cPE having less than about 5% by weight n-hexane extractable content. In another embodiment, non-cling layer 60 comprises PP. In yet another embodiment, non-cling layer 60 comprises HDPE. In one embodiment, non-cling layer 60 comprises LDPE. In one embodiment, non-cling layer 60 comprises a blend of cPE and one or more polymers selected from the group consisting of PP, HDPE, DB PE, EP copolymer and LDPE.

In one embodiment, non-cling layer 60 comprises a blend of PP and HDPE. In one embodiment, non-cling layer 60 comprises from about 60% to about 99% by weight PP and from about 1% to about 40% HDPE. In another embodiment, the blend comprises about 80% by weight PP and about 20% by weight HDPE. In yet another embodiment, the blend from about 75% to about 95% by weight PP and from about 5% to about 25% by weight HDPE.

In illustrative embodiments, non-cling layer 60 may include any of several non-cling or antiblock additives to improve the non-cling characteristics of the layer. Such additives include silicas, talcs, diatomaceous earth, silicates, lubricants, etc.

Intermediate layer 62 is interposed and arranged to contact non-cling layer 60 and core 16. In one aspect, intermediate layer 62 is chosen to increase compatibility between non-cling layer 60 and core 16. In one embodiment, intermediate layer 62 comprises cPE. In another embodiment, intermediate layer 62 comprises ZN PE. In another embodiment, intermediate layer 62 comprises VLDPE. In yet another embodiment, intermediate layer 62 comprises an elastomer. In yet another embodiment, intermediate layer 62 comprises ZN PE blended with one or more selected from the group consisting of plastomers, elastomers, DB, SBC, HDPE, EP copolymer, and LDPE.

Second exterior sheet 13. Referring again to FIG. 1, second exterior sheet 13 comprises an intermediate layer 64 and a cling layer 68. In one aspect, cling layer 68 comprises a polymer providing a cling property. In one embodiment, cling layer 68 comprises a blend of cPE and one or more polymers selected from the group consisting of plastomers, elastomers, EAC, SBC, PIB, EP copolymer, VLDPE, and LDPE. In another embodiment, cling layer 68 comprises ZN PE. In yet another embodiment, cling layer 68 comprises mPE.

In illustrative embodiments, cling layer 68 comprises VLDPE or blends thereof. In one embodiment, cling layer 68 comprises about 10% by weight to about 90% by weight VLDPE. In another embodiment, cling layer 68 comprises about 30% by weight to about 70% by weight VLDPE. In another embodiment, cling layer 68 comprises about 37% by weight to about 56% by weight VLDPE.

In further illustrative embodiments, cling layer 68 comprises an EP copolymer having a block microcrystalline orientation. In one embodiment, cling layer 68 comprises about 60% by weight to about 95% by weight EP copolymer. In another embodiment, cling layer 68 comprises about 75% by weight to about 85% by weight VLDPE. In another embodiment, cling layer 68 comprises about 80% by weight VLDPE.

In other illustrative embodiments, cling layer 68 comprises a SBC. In one embodiment, cling layer 68 comprises about 50% by weight to about 99% by weight SBC. In another embodiment, cling layer 68 comprises about 60% by weight to about 95% by weight SBC. In another embodiment, cling layer 68 comprises from about 68% to about 88% by weight SBC.

Intermediate layer 64 is interposed and arranged to contact cling layer 68 and core 16. In one aspect, intermediate layer 64 is chosen to increase compatibility between cling layer 68 and core 16. In one embodiment, intermediate layer 64 comprises cPE. In another embodiment, intermediate layer 64 comprises ZN PE. In another embodiment, intermediate layer 64 comprises VLDPE. In yet another embodiment, intermediate layer 64 comprises an elastomer. In yet another embodiment, intermediate layer 64 comprises ZN PE blended with one or more selected from the group consisting of plastomers, elastomers, DB, SBC, HDPE, EP copolymer, and LDPE.

Core 16. Referring again to FIG. 1, core 16 is interposed and arranged to contact first exterior sheet 11 and second exterior sheet 13. Core 16 comprises an interior polymer bed 22 interposed and arranged to contact first cPE sheet 18 and second cPE sheet 20. In one embodiment, first cPE sheet 18 comprises a first cPE layer 24 and a second cPE layer 26. In one aspect, first cPE layer 24 is selected in relation to selection of first exterior sheet 11 to provide for compatibility between first exterior sheet 11 and second cPE layer 26. In another aspect, second cPE layer 26 is selected in relation to selection of first cPE layer 24 and interior polymer bed 22. In one embodiment, first cPE sheet 18 comprises first cPE layer 24 having a first characteristic (e.g., first molecular weight) and second cPE layer 26 having a second characteristic (e.g., second molecular weight).

Referring again to FIG. 1, second cPE sheet 20 comprises a first cPE layer 28 and a second cPE layer 30. In one aspect, second cPE layer 30 is selected in relation to selection of second exterior sheet 13 to provide for compatibility between second exterior sheet 13 and first cPE layer 28. In another aspect, first cPE layer 28 is selected in relation to selection of second cPE layer 30 and interior polymer bed 22. In another embodiment, second cPE sheet 20 comprises a first cPE layer 28 comprising cPE having a third characteristic (e.g., third molecular weight) and second cPE layer 30 comprises cPE having a fourth characteristic (e.g., fourth molecular weight. In one embodiment, first cPE layer 24 and second cPE layer 30 comprise substantially equivalent cPE compositions. In another embodiment, first cPE layer 28 and second cPE layer 36 comprise substantially equivalent cPE compositions.

Interior polymer bed 22. Referring to FIG. 1, interior polymer bed 22 is interposed and arranged to contact first cPE sheet 18 and second cPE sheet 20. In one embodiment, interior polymer bed 22 comprises a first polymer buffer sheet 32, a second polymer buffer sheet 34, and a polymer sheet 36, interposed and arranged to contact first polymer buffer sheet 32 and second polymer buffer sheet 34. In one aspect, first polymer buffer sheet 32 is selected to provide compatibility between polymer sheet 36 and first cPE sheet 18. In another aspect, second polymer buffer sheet 34 is selected to provide compatibility between polymer sheet 36 and second cPE sheet 20.

In one embodiment, first polymer buffer sheet 32 comprises a blend of cPE and one or more polymers selected from the group consisting of plastomers, elastomers, EAC, SBC, PIB, DB PE, EP copolymers, and LDPE. In one embodiment, second polymer buffer sheet 34 comprises a blend of cPE and one or more polymers selected from the group consisting of plastomers, elastomers, EAC, SBC, PIB, EP copolymers, and LDPE. In one embodiment, the cPE is mPE. In another embodiment, the cPE is ZN PE.

In one embodiment, first polymer buffer sheet 32 comprises an elastomer. In another embodiment, second polymer buffer sheet 34 comprises an elastomer. In another embodiment, first polymer buffer sheet 32 comprises an EP copolymer. In another embodiment, second polymer buffer sheet 34 comprises an EP copolymer. In yet another embodiment, the first polymer buffer sheet 32 includes a DB PE. In yet another embodiment, second polymer buffer sheet 32 comprises DB PE.

In illustrative embodiments, core 16 exhibits C_{S}-type symmetry about polymer sheet 36. In one embodiment, interior polymer bed 22 exhibits C_{S}-type symmetry about polymer sheet 36. In one embodiment, a structure comprising core 16, intermediate layer 62, and intermediate layer 64 exhibits C_{S}-type symmetry about polymer sheet 36. In one embodiment, symmetry includes compositional and dimensional symmetry. In another embodiment, symmetry includes only compositional symmetry. In yet another embodiment, symmetry includes only dimensional symmetry.

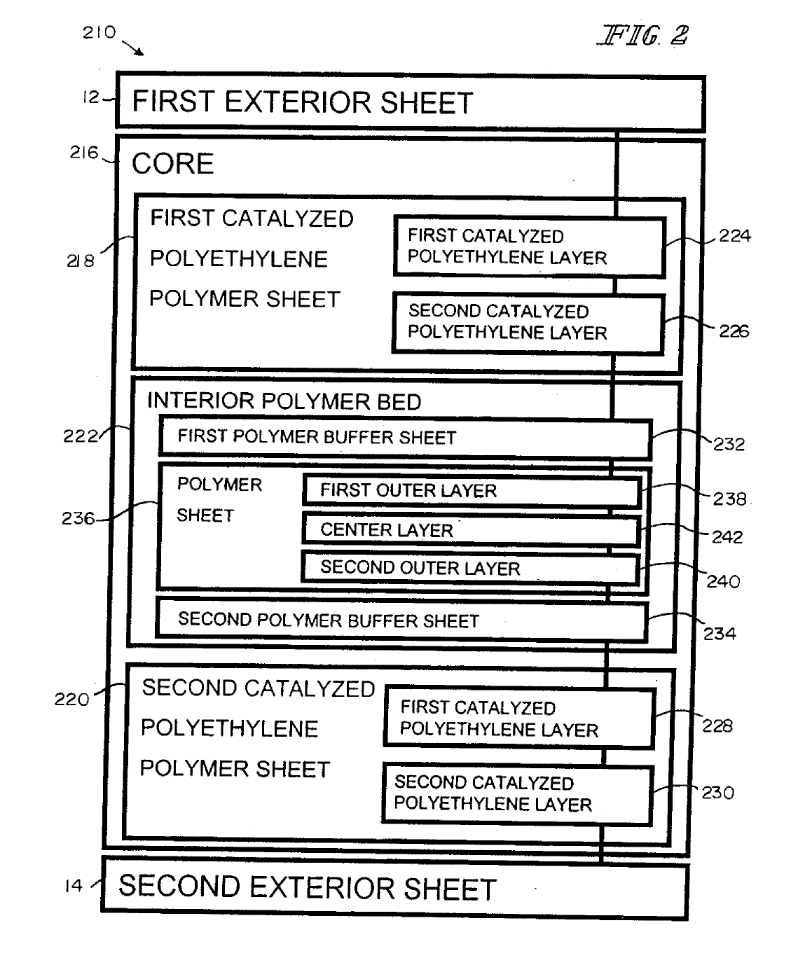

Referring now to FIG. 2, a multi-layer stretch film 210 comprises a first exterior sheet 12, a second exterior sheet 14, and a core 16 interposed and arranged to contact the first and second exterior sheets. Core 216 comprises an interior polymer bed 222 interposed and arranged to contact a first catalyzed polyethylene polymer sheet 218 and a second catalyzed polyethylene polymer sheet 220. Interior polymer bed 222 comprises a first polymer buffer sheet 232, a second polymer buffer sheet 234 and a polymer sheet 236, interposed and arranged to contact first polymer buffer sheet 232 and second polymer buffer sheet 234. Polymer sheet 236 comprises a first outer layer 238, a second outer layer 240, and a center layer 242 interposed and arranged to contact first outer layer 238 and second outer layer 240. First catalyzed polyethylene polymer sheet 218 comprises a first cPE layer 224 and a second cPE layer 226. Second catalyzed polyethylene polymer sheet 220 comprises a first cPE layer 228 and a second cPE layer 230.

First exterior sheet 12. In illustrative embodiments, first exterior sheet 12 comprises cPE. In another embodiment, first exterior sheet 12 comprises cPE having less than about 5% by weight n-hexane extractable content. In another embodiment, first exterior sheet 12 comprises PP. In yet another embodiment first exterior sheet 12 comprises HDPE. In one embodiment, first exterior sheet 12 comprises LDPE. In one embodiment, first exterior sheet 12 comprises a blend of cPE and one or more polymers selected from the group consisting of PP, HDPE, DB PE, EP copolymer and LDPE.

In one embodiment, first exterior sheet 12 comprises a blend of PP and HDPE. In one embodiment, first exterior sheet 12 comprises from about 60% to about 99% by weight PP and from about 1% to about 40% HDPE. In another embodiment, the blend comprises about 80% by weight PP and about 20% by weight HDPE. In yet another embodiment, the blend from about 75% to about 95% by weight PP and from about 5% to about 25% by weight HDPE. In yet another embodiment, first exterior sheet 12 includes any of several non-cling or antiblock additives to improve the slip characteristics of the layer. Such additives include silicas, talcs, diatomaceous earth, silicates, lubricants, etc.

In one aspect, first exterior sheet 12 comprises a polymer which provides a non-cling or low-cling property. In another aspect, first exterior sheet 12 comprises a polymer which provides a non-cling property. In one embodiment, first exterior sheet 12 comprises ZN PE containing less than about 5 weight percent of n-hexane extractables. In one embodiment, first exterior sheet 12 comprises a polymer composition providing an exterior surface of the first exterior sheet with a low coefficient of friction. For example, the coefficient of friction of first exterior sheet 12 is less than about 0.9. In one embodiment, the coefficient of friction of first exterior sheet 12 is about 0.5.

Second exterior sheet 14. In illustrative embodiments, second exterior sheet 14 comprises a polymer which provides a cling property. In one aspect, second exterior sheet 14 comprises a polymer providing a cling property. In one embodiment, second exterior sheet 14 comprises a blend of cPE and one or more polymers selected from the group consisting of plastomers, elastomers, EAC, SBC, PIB, EP copolymer, VLDPE, and LDPE. In another embodiment, second exterior sheet 14 comprises ZN PE. In yet another embodiment, exterior sheet 14 comprises mPE.

In illustrative embodiments, second exterior sheet 14 comprises VLDPE or blends thereof. In one embodiment, second exterior sheet 14 comprises about 10% by weight to about 90% by weight VLDPE. In another embodiment, exterior sheet 14 comprises about 30% by weight to about 70% by weight VLDPE. In another embodiment, second exterior sheet 14 comprises about 37% by weight to about 56% by weight VLDPE.

In further illustrative embodiments, second exterior sheet 14 comprises an EP copolymer having a block microcrystalline orientation. In one embodiment, second exterior sheet 14 comprises about 60% by weight to about 95% by weight EP copolymer. In another embodiment, second exterior sheet 14 comprises about 75% by weight to about 85% by weight VLDPE. In another embodiment, second exterior sheet 14 comprises about 80% by weight VLDPE.

In other illustrative embodiments, second exterior sheet 14 comprises a SBC. In one embodiment, second exterior sheet 14 comprises about 50% by weight to about 99% by weight SBC. In another embodiment, second exterior sheet 14 comprises about 60% by weight to about 95% by weight SBC. In another embodiment, second exterior sheet 14 comprises from about 68% to about 88% by weight SBC.

Core 216. Referring again to FIG. 2, interposed and arranged to contact first exterior sheet 12 and second exterior sheet 14 is core 216. In illustrative embodiments, core 216 comprises an interior polymer bed 222 interposed and arranged to contact a first cPE polymer sheet 218 and a second cPE polymer sheet 220. In one embodiment, first cPE polymer sheet 218 comprises a first cPE layer 224 and a second cPE layer 226. In one aspect, first cPE layer 224 is selected in relation to the selection of first exterior sheet 12 to provide for compatibility between first exterior sheet 12 and second cPE layer 226. In another aspect, second cPE layer 226 is selected in relation to selection of first cPE layer 224 and interior polymer bed 222. In one embodiment, first cPE polymer sheet 218 comprises first cPE layer 224 having a first characteristic (e.g., first molecular weight) and second cPE layer 226 having a second characteristic (e.g., second molecular weight). In one embodiment, second cPE polymer sheet 220 comprises first cPE layer 228 and second cPE layer 230. In one aspect, second cPE layer 230 is selected in relation to selection of second exterior sheet 14 to provide for compatibility between second exterior sheet 14 and first cPE layer 228. In another aspect, first cPE layer 228 is selected in relation to selection of second cPE layer 230 and interior polymer bed 222. In another embodiment, second cPE polymer sheet 220 comprises a first cPE layer 228 having a third characteristic (e.g., third molecular weight) and second cPE layer 230 having a fourth characteristic (e.g., fourth molecular weight).

Interior polymer bed 222. Interior polymer bed 222 is interposed and arranged to contact first cPE polymer sheet 218 and second cPE polymer sheet 220. In one embodiment, interior polymer bed 222 comprises a first polymer buffer sheet 232, a second polymer buffer sheet 234 and a polymer sheet 236, interposed and arranged to contact first polymer buffer sheet 232 and second polymer buffer sheet 234. In one aspect first polymer buffer sheet 232 is selected to provide compatibility between polymer sheet 236 and first cPE polymer sheet 218. In another aspect second polymer buffer sheet 234 is selected to provide for compatibility between polymer sheet 236 and second cPE polymer sheet 220. In one embodiment, first polymer buffer sheet 232 includes an elastomer. In another embodiment, second polymer buffer sheet 234 includes an elastomer. In another embodiment, first polymer buffer sheet 232 comprises an EP copolymer. In another embodiment second polymer buffer sheet 234 comprises an EP copolymer.

Polymer sheet 236. In illustrative embodiments, polymer sheet 236 comprises a first outer layer 238, a second outer layer 240, and a center layer 242. In one aspect, first outer layer 238, first polymer buffer sheet 232 and center layer 242 are chosen so first outer layer 238 is compatible with center layer 242 and first polymer buffer sheet 232. In another aspect, second outer layer 240, second polymer buffer sheet 234 and center layer 242 are selected so second outer layer 240 is compatible with center layer 242 and second polymer buffer sheet 234. In one embodiment, center layer 242 comprises PP. In another embodiment, center layer 242 comprises EP copolymer. In yet another embodiment, center layer 242 comprises elastomer. In another embodiment, center layer 242 comprises ZN PE. In another embodiment center layer 242 comprises octene ZN PE. In another embodiment, first outer layer 238 comprises EP copolymer. In another embodiment first outer layer 238 comprises PP. In another embodiment, first outer layer 238 comprises butene mPE. In another embodiment, second outer layer 240 comprises EP copolymer. In another embodiment, second outer layer 240 comprises PP. In another embodiment, second outer layer 240 comprises butene mPE.

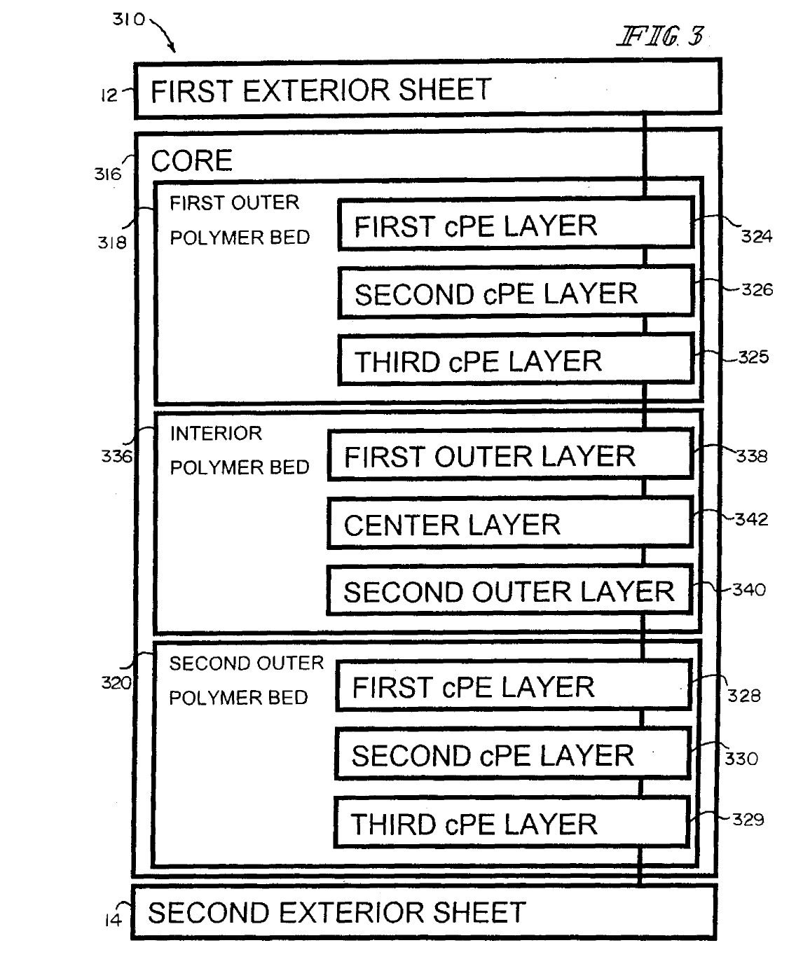

Referring now to FIG. 3, the multi-layer stretch film 310 comprises first exterior sheet 12, second exterior sheet 14 and a core 316 interposed and arranged to contact the first and second exterior sheets.

First outer polymer bed 318. First outer polymer bed 318 comprises a first cPE layer 324, a second cPE layer 326, and a third cPE layer 325. In one aspect, the first cPE layer 324 is selected in relation to selection of first exterior sheet 12 to provide for compatibility between first exterior sheet 12 and second cPE layer 326. In another aspect, second cPE layer 326 is selected in relation to selection of first cPE layer 324 and third cPE layer 325. In another aspect, third cPE layer 325 is selected in relation to selection of second cPE layer 326 and interior polymer bed 336.

In one embodiment, first cPE layer 324 comprises cPE having a molecular weight of 80 k g/mol and an alpha olefin content of 14% by weight. In another embodiment, second cPE 326 layer comprises cPE having a molecular weight of 85 k and an alpha olefin content of 15% by weight. In another embodiment, third cPE layer 325 comprises cPE polymer with molecular weight of 90 k and an alpha olefin content of 13% by weight. In one aspect, because of the similarity in chemical and physical properties and the thickness of the layers, the three layers may be essentially indistinguishable through analytical techniques.

In one embodiment, first outer polymer bed 318 comprises first cPE layer 324 having a first characteristic (e.g., first molecular weight), second cPE layer 326 having a second characteristic (e.g., second molecular weight) and third cPE layer 325 having a third characteristic (e.g., third molecular weight).

Second outer polymer bed 320. Second outer polymer bed 320 comprises a first cPE layer 328, a second cPE layer 330 and a third cPE layer 329. In one aspect, first cPE layer 328 is selected in relation to selection of interior polymer bed 336 and second cPE layer 330. In another aspect, second cPE layer 330 is selected in relation to selection of first cPE layer 328 and third cPE layer 329. In another aspect, third cPE layer 329 is selected in relation to second cPE layer 330 and second exterior sheet 14. In this manner each layer is selected to provide for compatibility between the two layers in which the subject layer is adjacent, interposed and in contact with.

In one embodiment, second outer polymer bed 320 comprises first cPE layer 328 having a fourth characteristic (e.g., fourth molecular weight), second cPE layer 330 having a fifth characteristic (e.g., fifth molecular weight) and third cPE layer 329 having a sixth characteristic (e.g., sixth molecular weight).

Core 316. In illustrative embodiments, core 316 comprises an interior polymer bed 336 interposed and arranged to contact a first outer polymer bed 318 and a second outer polymer bed 320. First outer polymer bed 318 and second outer polymer bed 320 each includes three or more catalyzed polyethylene (cPE) layers. In one embodiment, interior polymer bed 336 comprises a first outer layer 338, a second outer layer 340, and a center layer 342 interposed and arranged to contact first outer layer 338 and second outer layer 340.

In one aspect, first outer layer 338 is selected so it is compatible with center layer 342 and first outer polymer bed 318. In another aspect, second outer layer 340 is selected so it is compatible with center layer 342 and second outer polymer bed 320. In one embodiment, center layer 342 comprises PP. In another embodiment, center layer 342 comprises EP copolymer. In one embodiment, first outer layer 338 comprises elastomer. In another embodiment, second outer layer 340 comprises elastomer. In another embodiment, center layer 342 comprises ZN PE. In another embodiment, center layer 342 comprises octene ZN PE. In another embodiment, first outer layer 338 comprises EP copolymer. In another embodiment, first outer layer 338 comprises PP. In another embodiment, first outer layer 338 comprises butene mPE. In another embodiment, second outer layer 340 comprises EP copolymer.

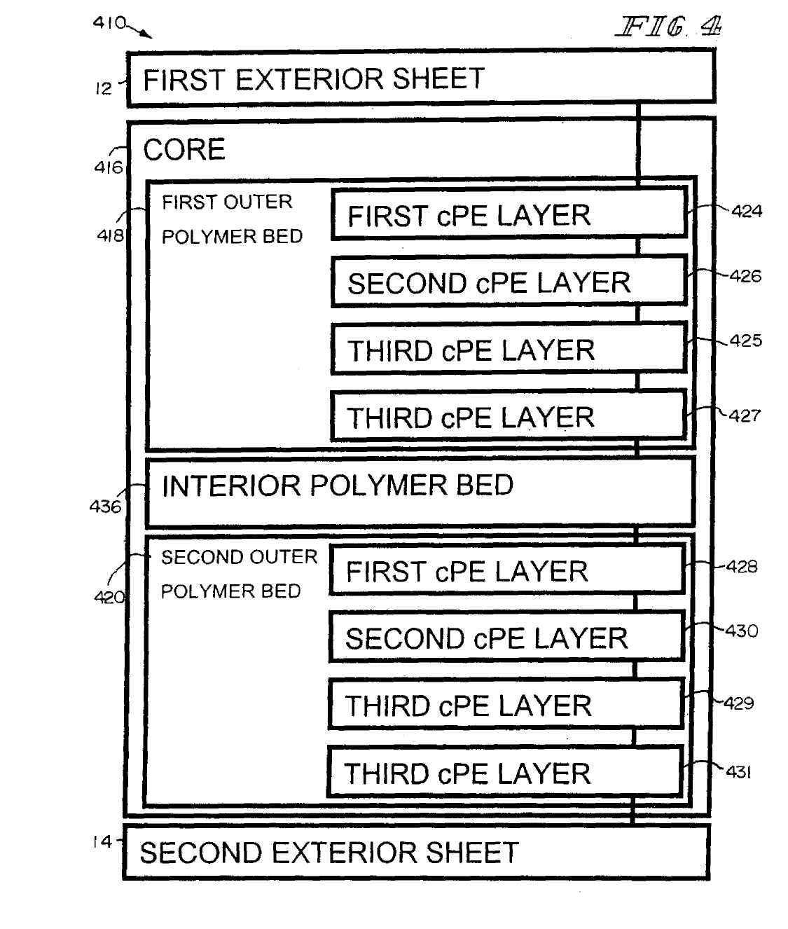

Referring now to FIG. 4, multi-layer stretch film 410 comprises first exterior sheet 12, second exterior sheet 14 and a core 416 interposed and arranged to contact the first and second exterior sheets.

Core 416. In illustrative embodiments, core 416 comprises an interior polymer bed 436 interposed and arranged to contact a first outer polymer bed 418 and a second outer polymer bed 420.

First outer polymer bed 418. In illustrative embodiments, first outer polymer bed 418 comprises a first cPE layer 424, a second cPE layer 426, a third cPE layer 425, and a fourth cPE layer 427. In one aspect, first cPE layer 424 is selected in relation to selection of first exterior sheet 12 to provide for compatibility between first exterior sheet 12 and second cPE layer 426. In another aspect, second cPE layer 426 is selected in relation to selection of first cPE layer 424 and third cPE layer 425. In another aspect, third cPE layer 425 is selected in relation to selection of second cPE layer 426 and fourth cPE layer 427. In another aspect, fourth cPE layer 427 is selected in relation to selection of third cPE layer 425 and interior polymer bed 436.

In one embodiment, first outer polymer bed 418 comprises first cPE layer 424 having a first characteristic (e.g., first molecular weight), second cPE layer 426 having a second characteristic (e.g., second molecular weight), third cPE layer 425 having a third characteristic (e.g., third molecular weight), and fourth cPE layer 427 having a fourth characteristic (e.g., fourth molecular weight).

Second outer polymer bed 420. In illustrative embodiments, second outer polymer bed 420 comprises first cPE layer 428, second cPE layer 430, third cPE layer 429, and fourth cPE layer 431. In one aspect, first cPE layer 428 is selected in relation to selection of interior polymer bed 436 and second cPE layer 430. In another aspect, second cPE layer 430 is selected in relation to selection of first cPE layer 428 and third cPE layer 429. In another aspect, third cPE layer 429 is selected in relation to second cPE layer 430 and fourth cPE layer 431. In another aspect, fourth cPE layer 431 is selected in relation to third cPE layer 429 and second exterior sheet 14. In this manner each layer is selected to provide for compatibility between the two layers in which the subject layer is adjacent, interposed and in contact with.

In one embodiment, second outer polymer bed 420 comprises first cPE layer 428 having a fifth characteristic (e.g., fifth molecular weight), second cPE layer 430 having a sixth characteristic (e.g., sixth molecular weight), third cPE layer 429 having a seventh characteristic (e.g., seventh molecular weight), and fourth cPE layer 431 having an eighth characteristic (e.g., eighth molecular weight).

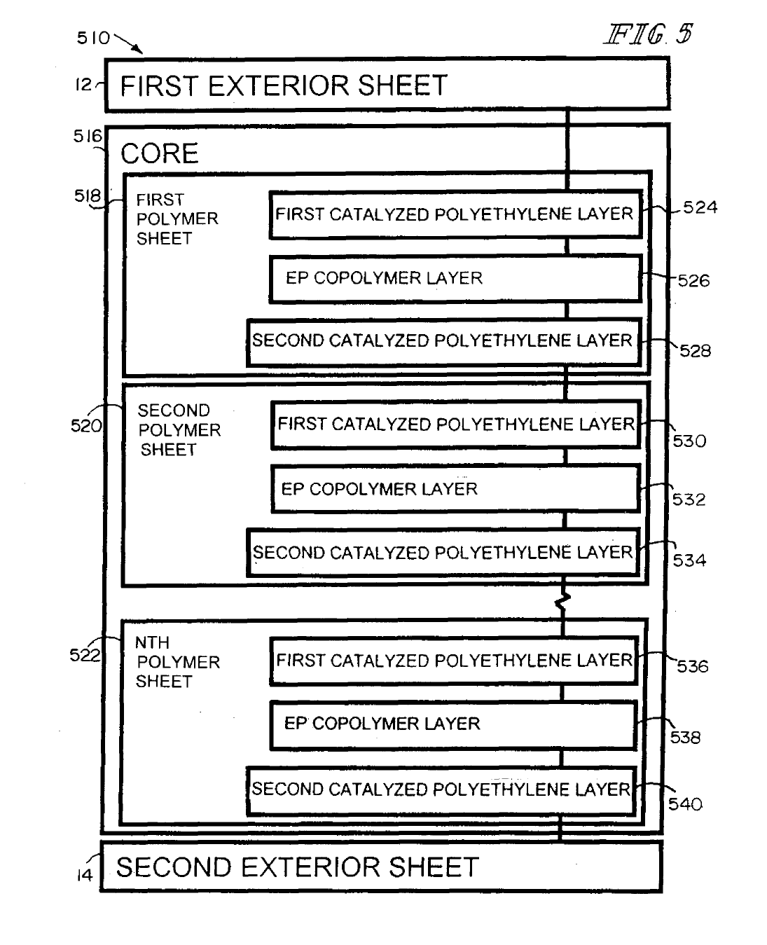

Referring now to FIG. 5, a multi-layer stretch film 510 comprises first exterior sheet 12, second exterior sheet 14 and a core 516 interposed and arranged to contact first and second exterior sheets.

Core 516. In illustrative embodiments, core 516 comprises a number (N) of polymer sheets. In one embodiment, the number of polymer sheets, N, may be two or greater. In another embodiment, the number, N, of polymer sheets may be between about two and about 20 polymer sheets. In yet another embodiment, the number of polymer sheets (N) may be between about two and about 10.

In illustrative embodiments, a polymer sheet may include one or more cPE layers, one or more elastomer layers, and one or more EP copolymer layers in any order. In one embodiment, the compositions of the layers are selected to provide compatibility between adjacent layers. In another embodiment, compatibilizing layers are arranged to contact and interposed between layers which may not exhibit good compatibility. For example, it may be preferred to include an elastomer layer between cPE layers and EP copolymer layers, depending on the characteristics of both cPE layer and the EP copolymer layer.

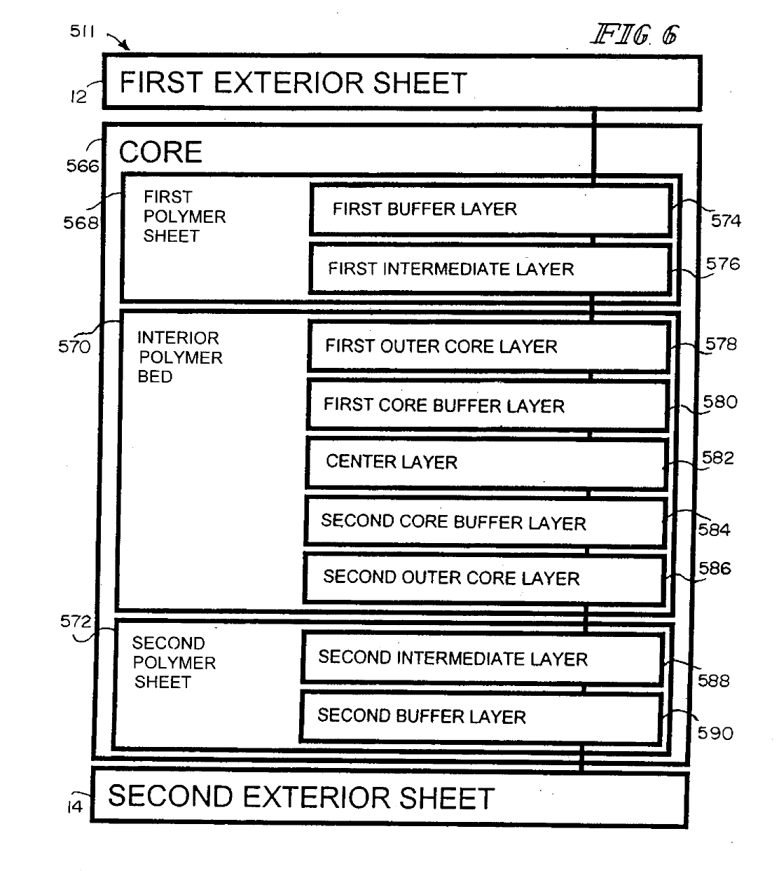

Referring now to FIG. 6, a multi-layer stretch film 511 comprises first exterior sheet 12, second exterior sheet 14 and a core 566 interposed and arranged to contact first and second exterior sheets.

Core 566. In illustrative embodiments, core 566 comprises an interior polymer bed 570 interposed and arranged to contact a first polymer sheet 568 and a second polymer sheet 572.

First polymer sheet 568. In illustrative embodiments, first polymer sheet 568 comprises a first buffer layer 574 and a first intermediate layer 576. In one aspect, first buffer layer 574 is selected in relation to selection of first exterior sheet 12 to provide for compatibility between first exterior sheet 12 and first intermediate layer 576. In another aspect, first intermediate layer 576 is selected in relation to selection of interior polymer bed 570 and first exterior sheet 12. In one embodiment, first buffer layer 574 comprises cPE. In another embodiment, first buffer layer 574 comprises EP copolymer. In another embodiment, first buffer layer 574 comprises a blend of cPE and LDPE. In another embodiment, first intermediate layer 576 comprises cPE. In another embodiment, first intermediate layer 576 comprises EP copolymer. In another embodiment, first intermediate layer 576 comprises a blend of cPE and LDPE.

Second polymer sheet 572. In illustrative embodiments, second polymer sheet 572 comprises a second buffer layer 590 and a second intermediate layer 588. In one aspect, second buffer layer 590 is selected in relation to selection of second exterior sheet 14 to provide for compatibility between second exterior sheet 14 and second intermediate layer 588. In another aspect, second intermediate layer 5ee is selected in relation to selection of interior polymer bed 570 and second exterior sheet 14. In one embodiment, second buffer layer 590 comprises cPE. In another embodiment, second buffer layer 590 comprises EP copolymer. In another embodiment, second buffer layer 590 comprises a blend of cPE and LDPE. In another embodiment, second intermediate layer 588 comprises cPE. In another embodiment, second intermediate layer 588 comprises EP copolymer. In another embodiment, second intermediate layer 588 comprises a blend of cPE and LDPE.

Interior polymer bed 570. Referring now to FIG. 6, interior polymer bed 570 may include, in a series, a first outer core layer 578, a first core buffer layer 580, a center layer 582, a second core buffer layer 584, and a second outer core layer 586. In one embodiment, first outer core layer 578 comprises cPE. In one embodiment, first outer core layer 578 comprises EP copolymer. In one embodiment, first outer core layer 578 comprises a blend of cPE and LDPE. In one embodiment, first core buffer layer 580 comprises cPE. In one embodiment, first core buffer layer 580 comprises EP copolymer. In one embodiment, first core buffer layer 580 comprises a blend of cPE and LDPE. In one embodiment, center layer 582 comprises cPE. In one embodiment, center layer 582 comprises EP copolymer. In one embodiment, center layer 582, comprises a blend of cPE and LDPE. In one embodiment, second core buffer layer 584 comprises cPE. In one embodiment, second core buffer layer 584 comprises EP copolymer. In one embodiment, second core buffer layer 584 comprises a blend of cPE and LDPE. In one embodiment, second outer core layer 586 comprises cPE. In one embodiment, second outer core layer 586 comprises EP copolymer. In one embodiment, second outer core layer 586 comprises a blend of cPE and LDPE.

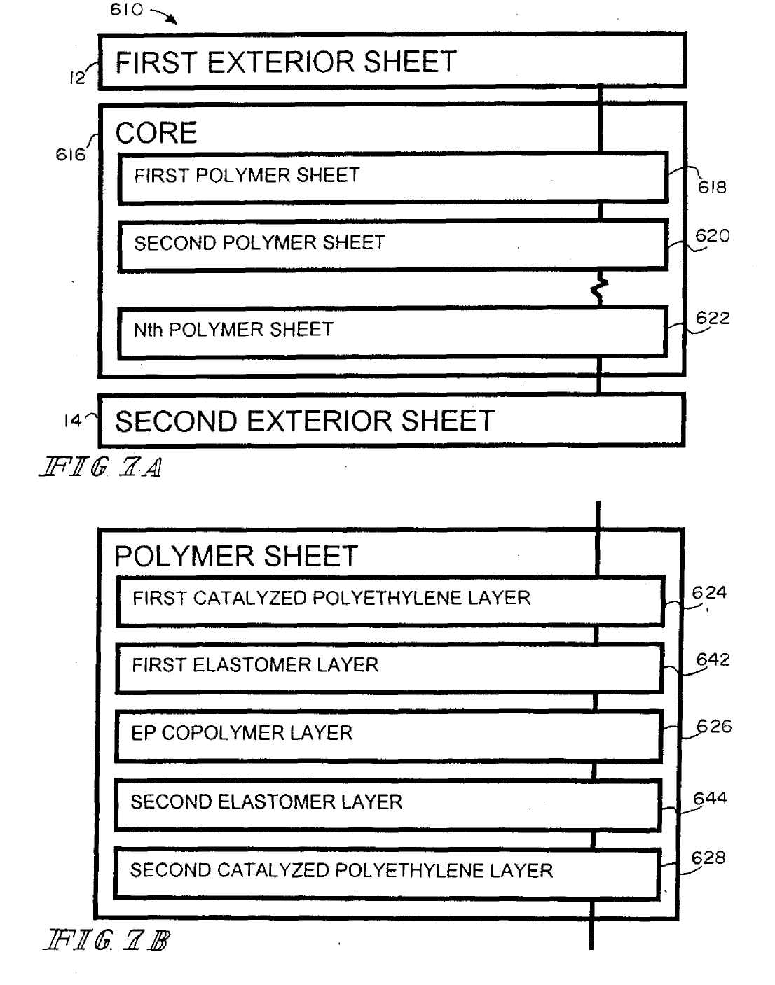

Referring now to FIG. 7A, a multi-layer stretch film 610 comprises first exterior sheet 12, second exterior sheet 14 and a core 616 interposed and arranged to contact the first and second exterior sheets.

Core 616. In illustrative embodiments, core 616 comprises a number of polymer sheets (N). In one embodiment, the number of polymer sheets, N, may be two or greater. In another embodiment, the number, N, of polymer sheets may be between about two and about 20 polymer sheets. In yet another embodiment, the number of polymer sheets may be between about two and about 10.

Referring now to FIG. 7B, polymer sheet 636 may include, in a series, first catalyzed polyethylene layer 624, first elastomer layer 642, EP copolymer layer 626, second elastomer layer 644 and second catalyzed polyethylene layer 628.

In illustrative embodiments, a polymer sheet may include, in a series, a first cPE layer, a first elastomer layer, an EP copolymer layer, a second elastomer layer and a second cPE layer. In one embodiment, a first cPE layer has a first characteristic (e.g., first molecular weight) and a second cPE layer has a second characteristic (e.g., second molecular weight). In another aspect, a first cPE layer 624 is selected in relation to the selection of first exterior sheet 12 to provide for compatibility between first exterior sheet 12 and first elastomer layer 642. In another aspect, first elastomer layer 642 is selected to provide compatibility between first cPE layer 624 and EP copolymer layer 626.

A polymer sheet may include one or more cPE layers, one or more elastomer layers, and one or more EP copolymer layers in any order. In one embodiment, the compositions of the layers are selected to provide compatibility between adjacent layers. In another embodiment, compatibilizing layers are arranged to contact and interposed between layers which may not exhibit good compatibility. For example, it may be preferred to include an elastomer layer between cPE layers and EP copolymer layers, depending on the characteristics of both cPE layer and the EP copolymer layer.

In another aspect, the multi-layer stretch film includes from about 60% to about 90% cPE, from about 5% to about 25% EP copolymer and from about 5% to about 15% of a non-cling and/or cling polymer. In another aspect, the multi-layer stretch film includes from about 60% to about 85% cPE, from about 5% to about 25% EP copolymer, from about 5% to about 30% elastomer and from about 5% to about 15% of a non-cling and/or cling polymer.

### EXAMPLES

The disclosure will be further described in connection with the following examples, which are set forth for purposes of illustration only. Parts and percentages appearing in such examples are by weight unless otherwise stipulated.

According to the film structure shown in FIG. 1, the following Tables 1-6 each indicate an exemplary embodiment of the present disclosure.

TABLE 1
Example 1

| | | First Polymer | density | MI | Second Polymer | density | MI | % Second |
|---|---|---|---|---|---|---|---|---|
| Layer | Example 1 | polymer type | (g/cm³) | (g/10 min) | polymer type | (g/cm³) | (g/10 min) | (%) |
| 1 | non-cling layer | ZN PE | 0.927 | 4.0 | | | | |
| 2 | intermediate layer | elastomer | 0.862 | 3.0 | | | | |
| 3 | first cPE layer | mPE | 0.918 | 4.0 | | | | |
| 4 | second cPE layer | mPE | 0.918 | 3.0 | | | | |
| 5 | first polymer buffer sheet | octene ZN PE | 0.918 | 2.0 | | | | |
| 6 | polymer sheet | EP copolymer | 0.900 | 8.0 | | | | |
| 7 | second polymer buffer sheet | octene ZN PE | 0.918 | 2.0 | | | | |
| 8 | first cPE layer | mPE | 0.918 | 3.0 | | | | |
| 9 | second cPE layer | mPE | 0.918 | 4.0 | | | | |
| 10 | intermediate layer | elastomer | 0.862 | 3.0 | | | | |
| 11 | cling layer | ZN PE | 0.918 | 3.3 | plastomer | 0.875 | 3.0 | 30 |

The first polymer column indicates the predominant polymer in each layer, wherein the second polymer column includes a polymer only if the given layer is a blend of two resins with distinct identifiable properties.

TABLE 2
Example 2

| | | First Polymer | density | MI | Second Polymer | density | MI | % Second |
|---|---|---|---|---|---|---|---|---|
| Layer | Example 2 | polymer type | (g/cm³) | (g/10 min) | polymer type | (g/cm³) | (g/10 min) | (%) |
| 1 | non-cling layer | mPE | 0.918 | 12.0 | | | | |
| 2 | intermediate layer | VLDPE | 0.904 | 4.0 | | | | |
| 3 | first cPE layer | mPE | 0.918 | 4.0 | | | | |
| 4 | second cPE layer | mPE | 0.918 | 3.0 | | | | |
| 5 | first polymer buffer sheet | elastomer | 0.862 | 3.0 | | | | |
| 6 | polymer sheet | EP copolymer | 0.900 | 8.0 | | | | |
| 7 | second polymer buffer sheet | elastomer | 0.862 | 3.0 | | | | |
| 8 | first cPE layer | mPE | 0.918 | 3.0 | | | | |
| 9 | second cPE layer | mPE | 0.918 | 4.0 | | | | |
| 10 | intermediate layer | VLDPE | 0.904 | 4.0 | | | | |
| 11 | cling layer | ZN PE | 0.918 | 3.3 | plastomer | 0.875 | 3.0 | 30 |

TABLE 3
Example 3

| | | First Polymer | density | MI | Second Polymer | density | MI | % Second |
|---|---|---|---|---|---|---|---|---|
| Layer | Example 3 | polymer type | (g/cm³) | (g/10 min) | polymer type | (g/cm³) | (g/10 min) | (%) |
| 1 | non-cling layer | ZN PE | 0.927 | 4.0 | | | | |
| 2 | intermediate layer | mPE | 0.917 | 4.0 | plastomer | 0.875 | 3.0 | 50 |
| 3 | first cPE layer | mPE | 0.918 | 4.0 | | | | |
| 4 | second cPE layer | mPE | 0.918 | 3.0 | | | | |
| 5 | first polymer buffer sheet | elastomer | 0.862 | 3.0 | | | | |
| 6 | polymer sheet | EP copolymer | 0.900 | 8.0 | | | | |
| 7 | second polymer buffer sheet | elastomer | 0.862 | 3.0 | | | | |
| 8 | first cPE layer | mPE | 0.918 | 3.0 | | | | |
| 9 | second cPE layer | mPE | 0.918 | 4.0 | | | | |
| 10 | intermediate layer | mPE | 0.917 | 4.0 | plastomer | 0.875 | 3.0 | 50 |
| 11 | cling layer | ZN PE | 0.918 | 3.3 | plastomer | 0.875 | 3.0 | 30 |

TABLE 4
Example 4

| | | First Polymer | density | MI | Second Polymer | density | MI | % Second |
|---|---|---|---|---|---|---|---|---|
| Layer | Example 4 | polymer type | (g/cm³) | (g/10 min) | polymer type | (g/cm³) | (g/10 min) | (%) |
| 1 | non-cling layer | mPE | 0.918 | 12.0 | | | | |
| 2 | intermediate layer | mPE | 0.917 | 4.0 | plastomer | 0.875 | 3.0 | 50 |
| 3 | first cPE layer | mPE | 0.918 | 4.0 | | | | |
| 4 | second cPE layer | mPE | 0.918 | 3.0 | | | | |
| 5 | first polymer buffer sheet | EP copolymer | 0.900 | 8.0 | | | | |
| 6 | polymer sheet | elastomer | 0.862 | 3.0 | | | | |
| 7 | second polymer buffer sheet | EP copolymer | 0.900 | 8.0 | | | | |
| 8 | first cPE layer | mPE | 0.918 | 3.0 | | | | |
| 9 | second cPE layer | mPE | 0.918 | 4.0 | | | | |
| 10 | intermediate layer | mPE | 0.917 | 4.0 | plastomer | 0.875 | 3.0 | 50 |
| 11 | cling layer | ZN PE | 0.918 | 3.3 | plastomer | 0.875 | 3.0 | 30 |

TABLE 5
Example 5

| | | First Polymer | density | MI | Second Polymer | density | MI | % Second |
|---|---|---|---|---|---|---|---|---|
| Layer | Example 5 | polymer type | (g/cm³) | (g/10 min) | polymer type | (g/cm³) | (g/10 min) | (%) |
| 1 | non-cling layer | ZN PE | 0.927 | 4.0 | | | | |
| 2 | intermediate layer | VLDPE | 0.904 | 4.0 | | | | |
| 3 | first cPE layer | mPE | 0.918 | 4.0 | | | | |
| 4 | second cPE layer | mPE | 0.918 | 3.0 | | | | |
| 5 | first polymer buffer sheet | EP copolymer | 0.900 | 8.0 | | | | |
| 6 | polymer sheet | elastomer | 0.862 | 3.0 | | | | |
| 7 | second polymer buffer sheet | EP copolymer | 0.900 | 8.0 | | | | |
| 8 | first cPE layer | mPE | 0.918 | 3.0 | | | | |
| 9 | second cPE layer | mPE | 0.918 | 4.0 | | | | |
| 10 | intermediate layer | VLDPE | 0.904 | 4.0 | | | | |
| 11 | cling layer | ZN PE | 0.918 | 3.3 | plastomer | 0.875 | 3.0 | 30 |

TABLE 6
Example 6

| | | First Polymer | density | MI | Second Polymer | density | MI | % Second |
|---|---|---|---|---|---|---|---|---|
| Layer | Example 6 | polymer type | (g/cm³) | (g/10 min) | polymer type | (g/cm³) | (g/10 min) | (%) |
| 1 | non-cling layer | ZN PE | 0.927 | 4.0 | | | | |
| 2 | intermediate layer | elastomer | 0.862 | 3.0 | | | | |
| 3 | first cPE layer | mPE | 0.918 | 4.0 | | | | |
| 4 | second cPE layer | mPE | 0.918 | 3.0 | | | | |
| 5 | first polymer buffer sheet | butene mPE | 0.918 | 2.5 | | | | |
| 6 | polymer sheet | EP copolymer | 0.900 | 8.0 | | | | |
| 7 | second polymer buffer sheet | butene mPE | 0.918 | 2.5 | | | | |
| 8 | first cPE layer | mPE | 0.918 | 3.0 | | | | |
| 9 | second cPE layer | mPE | 0.918 | 4.0 | | | | |
| 10 | intermediate layer | elastomer | 0.866 | 8.0 | | | | |
| 11 | cling layer | ZN PE | 0.918 | 3.3 | plastomer | 0.875 | 3.0 | 30 |

According to the film structure shown in FIG. 2, the following Tables 7-10 each indicate an exemplary embodiment of the present disclosure.

TABLE 7
Example 7

| | | First Polymer | density | MI | Second Polymer | density | MI | % Second |
|---|---|---|---|---|---|---|---|---|
| Layer | Example 7 | polymer type | (g/cm³) | (g/10 min) | polymer type | (g/cm³) | (g/10 min) | (%) |
| 1 | first exterior sheet | mPE | 0.918 | 12.0 | | | | |
| 2 | first cPE layer | mPE | 0.918 | 4.0 | | | | |
| 3 | second cPE layer | mPE | 0.918 | 3.0 | | | | |
| 4 | first polymer buffer sheet | elastomer | 0.866 | 8.0 | | | | |
| 5 | first outer layer | EP copolymer | 0.900 | 8.0 | | | | |
| 6 | center layer | PP | 0.902 | 5.0 | | | | |
| 7 | second outer layer | EP copolymer | 0.900 | 8.0 | | | | |
| 8 | second polymer buffer sheet | elastomer | 0.866 | 8.0 | | | | |
| 9 | first cPE layer | mPE | 0.918 | 3.0 | | | | |
| 10 | second cPE layer | mPE | 0.918 | 4.0 | | | | |
| 11 | second exterior sheet | ZN PE | 0.918 | 3.3 | plastomer | 0.875 | 3.0 | 30 |

TABLE 8
Example 8

| | | First Polymer | density | MI | Second Polymer | density | MI | % Second |
|---|---|---|---|---|---|---|---|---|
| Layer | Example 8 | polymer type | (g/cm³) | (g/10 min) | polymer type | (g/cm³) | (g/10 min) | (%) |
| 1 | first exterior sheet | ZN PE | 0.941 | 4.0 | | | | |
| 2 | first cPE layer | mPE | 0.918 | 5.0 | | | | |
| 3 | second cPE layer | mPE | 0.918 | 4.0 | | | | |
| 4 | first polymer buffer sheet | EP copolymer | 0.900 | 8.0 | | | | |
| 5 | first outer layer | PP | 0.900 | 7.0 | | | | |
| 6 | center layer | elastomer | 0.862 | 3.0 | | | | |
| 7 | second outer layer | PP | 0.900 | 7.0 | | | | |
| 8 | second polymer buffer sheet | EP copolymer | 0.900 | 8.0 | | | | |
| 9 | first cPE layer | mPE | 0.918 | 4.0 | | | | |
| 10 | second cPE layer | mPE | 0.918 | 5.0 | | | | |
| 11 | second exterior sheet | ZN PE | 0.918 | 3.3 | plastomer | 0.875 | 3.0 | 30 |

TABLE 9
Example 9

| | | First Polymer | density | MI | Second Polymer | density | MI | % Second |
|---|---|---|---|---|---|---|---|---|
| Layer | Example 9 | polymer type | (g/cm³) | (g/10 min) | polymer type | (g/cm³) | (g/10 min) | (%) |
| 1 | first exterior sheet | EP copolymer | 0.900 | 8.0 | | | | |
| 2 | first cPE layer | mPE | 0.918 | 5.0 | | | | |
| 3 | second cPE layer | mPE | 0.918 | 4.0 | | | | |
| 4 | first polymer buffer sheet | elastomer | 0.866 | 8.0 | | | | |
| 5 | first outer layer | EP copolymer | 0.900 | 8.0 | | | | |
| 6 | center layer | octene ZN PE | 0.900 | 8.0 | | | | |
| 7 | second outer layer | EP copolymer | 0.900 | 8.0 | | | | |
| 8 | second polymer buffer sheet | elastomer | 0.866 | 8.0 | | | | |
| 9 | first cPE layer | mPE | 0.918 | 4.0 | | | | |
| 10 | second cPE layer | mPE | 0.917 | 5.0 | | | | |
| 11 | second exterior sheet | ZN PE | 0.918 | 3.3 | plastomer | 0.875 | 3.0 | 30 |

TABLE 10
Example 10

| | | First Polymer | density | MI | Second Polymer | density | MI | % Second |
|---|---|---|---|---|---|---|---|---|
| Layer | Example 10 | polymer type | (g/cm³) | (g/10 min) | polymer type | (g/cm³) | (g/10 min) | (%) |
| 1 | first exterior sheet | ZN PE | 0.927 | 4.0 | | | | |
| 2 | first cPE layer | mPE | 0.917 | 5.0 | | | | |
| 3 | second cPE layer | mPE | 0.918 | 4.0 | | | | |
| 4 | first polymer buffer sheet | elastomer | 0.866 | 8.0 | | | | |
| 5 | first outer layer | butene mPE | 0.918 | 2.5 | | | | |
| 6 | center layer | EP copolymer | 0.902 | 6.5 | | | | |
| 7 | second outer layer | butene mPE | 0.918 | 2.5 | | | | |
| 8 | second polymer buffer sheet | elastomer | 0.866 | 8.0 | | | | |
| 9 | first cPE layer | mPE | 0.918 | 4.0 | | | | |
| 10 | second cPE layer | mPE | 0.918 | 5.0 | | | | |
| 11 | second exterior sheet | ZN PE | 0.918 | 3.3 | plastomer | 0.875 | 3.0 | 30 |

According to the film structure shown in FIG. 3, the following Tables 11-12 indicate exemplary embodiments of the present disclosure.

TABLE 11
Example 11

| | | First Polymer | density | MI | Second Polymer | density | MI | % Second |
|---|---|---|---|---|---|---|---|---|
| Layer | Example 11 | polymer type | (g/cm³) | (g/10 min) | polymer type | (g/cm³) | (g/10 min) | (%) |
| 1 | first exterior sheet | ZN PE | 0.927 | 4.0 | | | | |
| 2 | first cPE layer | mPE | 0.918 | 4.0 | | | | |
| 3 | second cPE layer | mPE | 0.918 | 3.5 | | | | |
| 4 | third cPE layer | mPE | 0.918 | 3.0 | | | | |
| 5 | first outer layer | elastomer | 0.866 | 8.0 | | | | |
| 6 | center layer | PP | 0.902 | 5.0 | | | | |
| 7 | second outer layer | elastomer | 0.866 | 8.0 | | | | |
| 8 | first cPE layer | mPE | 0.918 | 3.0 | | | | |
| 9 | second cPE layer | mPE | 0.918 | 3.5 | | | | |
| 10 | third cPE layer | mPE | 0.918 | 4.0 | | | | |
| 11 | second exterior sheet | ZN PE | 0.918 | 3.3 | plastomer | 0.875 | 3.0 | 30 |

TABLE 12
Example 12

| | | First Polymer | density | MI | Second Polymer | density | MI | % Second |
|---|---|---|---|---|---|---|---|---|
| Layer | Example 12 | polymer type | (g/cm³) | (g/10 min) | polymer type | (g/cm³) | (g/10 min) | (%) |
| 1 | first exterior sheet | mPE | 0.918 | 5.0 | ZN PE | 0.927 | 4.0 | 30 |
| 2 | first cPE layer | mPE | 0.918 | 5.0 | LDPE | 0.921 | 0.3 | 3 |
| 3 | second cPE layer | mPE | 0.918 | 5.0 | LDPE | 0.921 | 0.3 | 3 |
| 4 | third cPE layer | mPE | 0.918 | 5.0 | LDPE | 0.921 | 0.3 | 3 |
| 5 | first outer layer | EP Copolymer | 0.900 | 8.0 | | | | |
| 6 | center layer | mPE | 0.918 | 5.0 | LDPE | 0.921 | 0.3 | 3 |
| 7 | second outer layer | EP Copolymer | 0.900 | 8.0 | | | | |
| 8 | first cPE layer | mPE | 0.918 | 5.0 | LDPE | 0.921 | 0.3 | 3 |
| 9 | second cPE layer | mPE | 0.918 | 5.0 | LDPE | 0.921 | 0.3 | 3 |
| 10 | third cPE layer | mPE | 0.918 | 5.0 | LDPE | 0.921 | 0.3 | 3 |
| 11 | second exterior sheet | ZN PE | 0.918 | 3.3 | Plastomer | 0.875 | 3.0 | 30 |

According to the film structure shown in FIG. 4, the following Table 13 indicates an exemplary embodiment of the present disclosure.

TABLE 13
Example 13

| | | First Polymer | density | MI | Second Polymer | density | MI | % Second |
|---|---|---|---|---|---|---|---|---|
| Layer | Example 13 | polymer type | (g/cm³) | (g/10 min) | polymer type | (g/cm³) | (g/10 min) | (%) |
| 1 | first exterior sheet | EP copolymer | 0.901 | 7.0 | | | | |
| 2 | first cPE layer | mPE | 0.918 | 5.0 | | | | |
| 3 | second cPE layer | mPE | 0.918 | 4.0 | LDPE | 0.924 | 1.5 | 2 |
| 4 | third cPE layer | mPE | 0.918 | 3.5 | LDPE | 0.920 | 1.2 | 2 |
| 5 | fourth cPE layer | mPE | 0.918 | 3.0 | LDPE | 0.920 | 1.0 | 2 |
| 6 | center layer | EP copolymer | 0.900 | 8.0 | | | | |
| 7 | first cPE layer | mPE | 0.918 | 3.0 | LDPE | 0.920 | 1.0 | 2 |
| 8 | second cPE layer | mPE | 0.918 | 3.5 | LDPE | 0.920 | 1.2 | 2 |
| 9 | third cPE layer | mPE | 0.918 | 4.0 | LDPE | 0.924 | 1.5 | 2 |
| 10 | fourth cPE layer | mPE | 0.918 | 5.0 | | | | |
| 11 | second exterior sheet | mPE | 0.918 | 3.3 | plastomer | 0.861 | 18.0 | 20 |

According to the film structure shown in FIG. 5, the following Tables 14-15 indicate exemplary embodiments of the present disclosure.

TABLE 14
Example 14

| | | First Polymer | density | MI | Second Polymer | density | MI | % Second |
|---|---|---|---|---|---|---|---|---|
| Layer | Example 14 | polymer type | (g/cm³) | (g/10 min) | polymer type | (g/cm³) | (g/10 min) | (%) |
| 1 | first exterior sheet | mPE | 0.918 | 12.0 | | | | |
| . | | | | | | | | |
| . | | | | | | | | |
| . | | | | | | | | |
| X1 | first cPE layer | mPE | 0.918 | 4.0 | | | | |
| X2 | EP copolymer layer | EP copolymer | 0.900 | 8.0 | | | | |
| X3 | second cPE layer | mPE | 0.918 | 3.0 | | | | |
| . | | | | | | | | |
| . | | | | | | | | |
| . | | | | | | | | |
| . | | | | | | | | |
| . | | | | | | | | |
| . | | | | | | | | |
| 4 X | | | | | | | | |
| . | | | | | | | | |
| . | | | | | | | | |
| . | | | | | | | | |
| . | | | | | | | | |
| . | | | | | | | | |
| . | | | | | | | | |
| 17 | second exterior sheet | mPE | 0.918 | 3.3 | plastomer | 0.861 | 18.0 | 20 |

According to Example 14, the layers X1, X2, and X3 are repeated five times within the core. This is designated as one set written out and the other four replicate layer sets listed as 4X.

TABLE 15
Example 15

| | | First Polymer | density | MI | Second Polymer | density | MI | % Second |
|---|---|---|---|---|---|---|---|---|
| Layer | Example 15 | polymer type | (g/cm³) | (g/10 min) | polymer type | (g/cm³) | (g/10 min) | (%) |
| 1 | first exterior sheet | mPE | 0.918 | 5.0 | ZN PE | 0.927 | 4.0 | 30 |
| 2 | X1 | mPE | 0.918 | 5 | EP Copolymer | 0.866 | 3.0 | 10 |
| 3 | X2 | EP Copolymer | 0.900 | 8.0 | | | | |
| 4 | X3 | mPE | 0.918 | 5.0 | HP LDPE | 0.921 | 0.3 | 3 |
| 5 | Y1 | mPE | 0.918 | 5.0 | HP LDPE | 0.921 | 0.3 | 3 |
| 6 | Y2 | EP Copolymer | 0.900 | 8.0 | | | | |
| 7 | Y3 | mPE | 0.918 | 5.0 | HP LDPE | 0.921 | 0.3 | 3 |
| 8 | Z1 | mPE | 0.918 | 5.0 | HP LDPE | 0.921 | 0.3 | 3 |
| 9 | Z2 | EP Copolymer | 0.900 | 8.0 | | | | |
| 10 | Z3 | mPE | 0.918 | 5.0 | EP Copolymer | 0.866 | 3.0 | 10 |
| 11 | second exterior sheet | ZN PE | 0.918 | 3.3 | Plastomer | 0.875 | 3.0 | 30 |

According to the film structure shown in FIG. 6, the following Tables 16-19 indicate exemplary embodiments of the present disclosure.

TABLE 16
Example 16

| | | First Polymer | density | MI | Second Polymer | density | MI | % Second |
|---|---|---|---|---|---|---|---|---|
| Layer | Example 16 | polymer type | (g/cm³) | (g/10 min) | polymer type | (g/cm³) | (g/10 min) | (%) |
| 1 | first exterior sheet | mPE | 0.918 | 5.0 | ZN PE | 0.927 | 4.0 | 30 |
| 2 | first cPE layer | mPE | 0.918 | 5.0 | LDPE | 0.921 | 0.3 | 3 |
| 3 | EP copolymer layer | EP Copolymer | 0.900 | 8.0 | | | | |
| 4 | second cPE layer | mPE | 0.918 | 5.0 | LDPE | 0.921 | 0.3 | 3 |
| 5 | EP copolymer layer | EP Copolymer | 0.900 | 8.0 | | | | |
| 6 | third cPE layer | mPE | 0.918 | 5.0 | LDPE | 0.921 | 0.3 | 3 |
| 7 | EP copolymer layer | EP Copolymer | 0.900 | 8.0 | | | | |
| 8 | fourth cPE layer | mPE | 0.918 | 5.0 | LDPE | 0.921 | 0.3 | 3 |
| 9 | EP copolymer layer | EP Copolymer | 0.900 | 8.0 | | | | |
| 10 | fifth cPE layer | mPE | 0.918 | 5.0 | LDPE | 0.921 | 0.3 | 3 |
| 11 | second exterior sheet | ZN PE | 0.918 | 3.3 | Plastomer | 0.875 | 3.0 | 30 |

TABLE 17
Example 17

| | | First Polymer | density | MI | Second Polymer | density | MI | % Second |
|---|---|---|---|---|---|---|---|---|
| Layer | Example 17 | polymer type | (g/cm³) | (g/10 min) | polymer type | (g/cm³) | (g/10 min) | (%) |
| 1 | first exterior sheet | EP Copolymer | 0.900 | 8.0 | | | | |
| 2 | first buffer layer | mPE | 0.918 | 5.0 | LDPE | 0.921 | 0.3 | 3 |
| 3 | first intermediate layer | EP Copolymer | 0.900 | 8.0 | | | | |
| 4 | first outer core layer | mPE | 0.918 | 5.0 | LDPE | 0.921 | 0.3 | 3 |
| 5 | first core buffer layer | EP Copolymer | 0.900 | 8.0 | | | | |
| 6 | center layer | mPE | 0.918 | 5.0 | LDPE | 0.921 | 0.3 | 3 |
| 7 | second core buffer layer | EP Copolymer | 0.900 | 8.0 | | | | |
| 8 | second outer core layer | mPE | 0.918 | 5.0 | LDPE | 0.921 | 0.3 | 3 |
| 9 | second intermediate layer | EP Copolymer | 0.900 | 8.0 | | | | |
| 10 | second buffer layer | mPE | 0.918 | 5.0 | LDPE | 0.921 | 0.3 | 3 |
| 11 | second exterior sheet | ZN PE | 0.918 | 3.3 | Plastomer | 0.875 | 3.0 | 30 |

TABLE 18
Example 18

| | | First Polymer | density | MI | Second Polymer | density | MI | % Second |
|---|---|---|---|---|---|---|---|---|
| Layer | Example 18 | polymer type | (g/cm³) | (g/10 min) | polymer type | (g/cm³) | (g/10 min) | (%) |
| 1 | first exterior sheet | mPE | 0.918 | 5.0 | ZN PE | 0.927 | 4.0 | 30 |
| 2 | first buffer layer | mPE | 0.918 | 5.0 | EP Copolymer | 0.866 | 3.0 | 10 |
| 3 | first intermediate layer | EP Copolymer | 0.900 | 8.0 | | | | |
| 4 | first outer core layer | mPE | 0.918 | 5.0 | LDPE | 0.921 | 0.3 | 3 |
| 5 | first core buffer layer | EP Copolymer | 0.900 | 8.0 | | | | |
| 6 | center layer | mPE | 0.918 | 5.0 | LDPE | 0.921 | 0.3 | 3 |
| 7 | second core buffer layer | EP Copolymer | 0.900 | 8.0 | | | | |
| 8 | second outer core layer | mPE | 0.918 | 5.0 | LDPE | 0.921 | 0.3 | 3 |
| 9 | second intermediate layer | EP Copolymer | 0.900 | 8.0 | | | | |
| 10 | second buffer layer | mPE | 0.918 | 5.0 | EP Copolymer | 0.866 | 3.0 | 10 |
| 11 | second exterior sheet | ZN PE | 0.918 | 3.3 | Plastomer | 0.875 | 3.0 | 30 |

TABLE 19
Example 19

| | | First Polymer | density | MI | Second Polymer | density | MI | % Second |
|---|---|---|---|---|---|---|---|---|
| Layer | Example 19 | polymer type | (g/cm³) | (g/10 min) | polymer type | (g/cm³) | (g/10 min) | (%) |
| 1 | first exterior sheet | EP Copolymer | 0.900 | 8.0 | | | | |
| 2 | first buffer layer | mPE | 0.918 | 5.0 | EP Copolymer | 0.866 | 3.0 | 10 |
| 3 | first intermediate layer | EP Copolymer | 0.900 | 8.0 | | | | |
| 4 | first outer core layer | mPE | 0.918 | 5.0 | LDPE | 0.921 | 0.3 | 3 |
| 5 | first core buffer layer | EP Copolymer | 0.900 | 8.0 | | | | |
| 6 | center layer | mPE | 0.918 | 5.0 | LDPE | 0.921 | 0.3 | 3 |
| 7 | second core buffer layer | EP Copolymer | 0.900 | 8.0 | | | | |
| 8 | second outer core layer | mPE | 0.918 | 5.0 | LDPE | 0.921 | 0.3 | 3 |
| 9 | second intermediate layer | EP Copolymer | 0.900 | 8.0 | | | | |
| 10 | second buffer layer | mPE | 0.918 | 5.0 | EP Copolymer | 0.866 | 3.0 | 10 |
| 11 | second exterior sheet | ZN PE | 0.918 | 3.3 | Plastomer | 0.875 | 3.0 | 30 |

According to the film structure shown in FIG. 7A-B, the following Tables 20-22 indicate exemplary embodiments of the present disclosure.

TABLE 20
Example 20

| | | First Polymer | density | MI | Second Polymer | density | MI | % Second |
|---|---|---|---|---|---|---|---|---|
| Layer | Example 20 | polymer type | (g/cm³) | (g/10 min) | polymer type | (g/cm³) | (g/10 min) | (%) |
| 1 | first exterior sheet | ZN PE | 0.941 | 4.0 | | | | |
| . | | | | | | | | |
| . | | | | | | | | |
| . | | | | | | | | |
| X1 | first cPE layer | mPE | 0.918 | 3.0 | | | | |
| X2 | EP copolymer layer | EP copolymer | 0.900 | 7.0 | | | | |
| X3 | second cPE layer | mPE | 0.918 | 3.0 | | | | |
| . | | | | | | | | |
| . | | | | | | | | |
| . | | | | | | | | |
| . | | | | | | | | |
| . | | | | | | | | |
| . | | | | | | | | |
| 3 X | | | | | | | | |
| . | | | | | | | | |
| . | | | | | | | | |
| . | | | | | | | | |
| . | | | | | | | | |
| . | | | | | | | | |
| . | | | | | | | | |
| 14 | second exterior sheet | hexene ZN PE | 0.918 | 3.2 | plastomer | 0.875 | 3.0 | 10 |

According to Example 20, the layers X1, X2, and X3 are repeated four times within the core. This is designated as one set written out and the other three replicate layer sets listed as 3X.

TABLE 21
Example 21

| | | First Polymer | density | MI | Second Polymer | density | MI | % Second |
|---|---|---|---|---|---|---|---|---|
| Layer | Example 21 | polymer type | (g/cm³) | (g/10 min) | polymer type | (g/cm³) | (g/10 min) | (%) |
| 1 | first exterior sheet | ZN PE | 0.935 | 3.0 | | | | |
| . | | | | | | | | |
| . | | | | | | | | |
| . | | | | | | | | |
| X1 | first cPE layer | mPE | 0.918 | 3.0 | LDPE | 0.920 | 1.2 | 2 |
| X2 | first elastomer layer | elastomer | 0.862 | 3.0 | | | | |
| X3 | EP copolymer layer | EP copolymer | 0.900 | 8.0 | | | | |
| X5 | second elastomer layer | elastomer | 0.862 | 3.0 | | | | |
| X6 | second cPE layer | mPE | 0.918 | 3.0 | LDPE | 0.924 | 1.5 | 2 |
| . | | | | | | | | |
| . | | | | | | | | |
| . | | | | | | | | |
| 9 X | | | | | | | | |
| . | | | | | | | | |
| . | | | | | | | | |
| . | | | | | | | | |
| 62 | second exterior sheet | ZN PE | 0.918 | 3.3 | plastomer | 0.875 | 3.0 | 30 |

According to Example 21, the layers X1, X2, X3, X4, X5, and X6 are repeated ten times within the core. This is designated as one set written out and the other nine replicate layers listed as 9X.

TABLE 22
Example 22

| | | First Polymer | density | MI | Second Polymer | density | MI | % Second |
|---|---|---|---|---|---|---|---|---|
| Layer | Example 22 | polymer type | (g/cm³) | (g/10 min) | polymer type | (g/cm³) | (g/10 min) | (%) |
| 1 | first exterior sheet | ZN PE | 0.941 | 4.0 | | | | |
| X1 | first cPE layer | mPE | 0.918 | 3.0 | | | | |
| X2 | first elastomer layer | elastomer | 0.862 | 3.0 | | | | |
| X3 | EP copolymer layer | EP copolymer | 0.900 | 8.0 | | | | |
| X5 | second elastomer layer | elastomer | 0.862 | 3.0 | | | | |
| X6 | second cPE layer | mPE | 0.918 | 3.0 | | | | |
| Y1 | first cPE layer | mPE | 0.918 | 4.0 | | | | |
| Y2 | first elastomer layer | elastomer | 0.862 | 3.0 | | | | |
| Y3 | EP copolymer layer | EP copolymer | 0.900 | 8.0 | | | | |
| Y5 | second elastomer layer | elastomer | 0.862 | 3.0 | | | | |
| Y6 | second cPE layer | mPE | 0.918 | 4.0 | | | | |
| X₂ | | | | | | | | |
| Y₂ | | | | | | | | |
| X₃ | | | | | | | | |
| 32 | second exterior sheet | ZN PE | 0.918 | 3.3 | plastomer | 0.875 | 3.0 | 30 |

According to Example 22, the layer set that includes X1, X2, X3, X4, X5, and X6 are repeated three times within the core. Interposed between these repetitions is the layer set that includes Y1, Y2, Y3, Y4, Y5, and Y6. The X layer set is written out in one case and designated as X2 and X3 for the additional layer sets. The Y layer set is written out in one case and designated as Y2 for the additional layer set.

All patents, applications and published documents referred to herein are incorporated by reference in their entirety.

1. A multi-layer film comprising
a. a first exterior sheet comprising a cling layer and a first intermediate layer;
b. a second exterior sheet comprising a non-cling layer and a second intermediate layer, and
c. at least one core interposed between the first and second exterior sheets, the core comprising,
(i) an interior polymer bed comprising,
(1) a first polymer buffer sheet,
(2) a second polymer buffer sheet, and
(3) a polymer sheet interposed between the first and second polymer buffer sheets,
(ii) a first catalyzed polyethylene polymer sheet interposed between the polymer sheet and the first exterior sheet, and
(iii) a second catalyzed polyethylene polymer sheet interposed between the polymer sheet and the second exterior sheet.

2. The stretch film of claim 1, wherein the first catalyzed polyethylene polymer sheet comprises a first catalyzed polyethylene layer comprising a first catalyzed polyethylene having a first density and a second catalyzed polyethylene layer comprising a second catalyzed polyethylene having a second density, wherein the first density and the second density are both in the range from about 0.91 g/cm³ to about 0.94 g/cm³ and
the second catalyzed polyethylene polymer sheet comprises a third catalyzed polyethylene layer comprising a third catalyzed polyethylene having a third density and a fourth catalyzed polyethylene layer comprising a fourth catalyzed polyethylene having a fourth density, wherein the third density and the fourth density are both in the range from about 0.91 g/cm³ to about 0.94 g/cm³.

3. The stretch film of claim 2, wherein a first melt index of the first catalyzed polyethylene layer is greater than a second melt index of the second catalyzed polyethylene layer and
a third melt index of the third catalyzed polyethylene layer is greater than a fourth melt index of the fourth catalyzed polyethylene layer.

4. The stretch film of claim 3, wherein the wherein the first melt index, the second melt index, the third melt index, and the fourth index are each in the range of about 1 g/10 min to about 6 g/10 min.

5. The stretch film of claim 4, wherein the microcrystalline orientation of the first catalyzed polyethylene sheet and the second catalyzed polyethylene sheet is spherulite-like.

6. The stretch film of claim 1, wherein
the cling layer comprises a first catalyzed polyethylene and a plastomer,
the non-cling layer comprises a second catalyzed polyethylene, and
the polymer sheet comprises an ethylene propylene copolymer having a density of about 0.88 g/cm³ to about 0.92 g/cm³ and a MI of about 4 g/10 min to about 14 g/10 min.

7. The stretch film of claim 6, wherein
the first polymer buffer sheet comprises a third catalyzed polyethylene, the third catalyzed polyethylene being a first copolymer of ethylene and from about 1% to about 10% by weight octene and
the second polymer buffer sheet comprises a fourth catalyzed polyethylene, the fourth catalyzed polyethylene being a second copolymer of ethylene and from about 1% to about 10% by weight octene.

8. The stretch film of claim 6, wherein
the first catalyzed polyethylene has a density of about 0.91 g/cm³ to about 0.93 g/cm³ and a MI of about 2 g/10 min to about 5 g/10 min,
the plastomer has a density of about 0.86 g/cm³ to about 0.89 g/cm³ and a MI of about 2 g/10 min to about 5 g/10 min,
the second catalyzed polyethylene has a density of about 0.92 g/cm³ to about 0.94 g/cm³ and a MI of about 2 g/10 min to about 6 g/10 min, and
the polymer sheet comprises an ethylene propylene copolymer having a density of about 0.880 g/cm³ to about 0.92 g/cm³ and a MI of about 4 g/10 min to about 14 g/10 min.

9. A multi-layer stretch film comprising
a first exterior sheet,
a second exterior sheet, and
a core interposed between the first and second exterior sheets, the core comprising,
an interior polymer bed comprising a first polymer buffer sheet, a second polymer buffer sheet, and a polymer sheet interposed between the first and second polymer buffer sheets, the polymer sheet comprising a first outer layer, a second outer layer, and a center layer interposed between the first outer layer and the second outer layer,
a first catalyzed polyethylene polymer sheet interposed between the interior polymer bed and the first exterior sheet, and
a second catalyzed polyethylene polymer sheet interposed between the interior polymer bed and the second exterior sheet.

10. The stretch film of claim 9, wherein the first exterior sheet comprises a first catalyzed polyethylene having a density of about 0.91 g/cm³ to about 0.93 g/cm³ and a MI of about 8 g/10 min to about 16 g/10 min and
the second exterior sheet comprises a second catalyzed polyethylene having a density of about 0.91 g/cm³ to about 0.93 g/cm³ and a MI of about 2 g/10 min to about 4 g/10 min.

11. The stretch film of claim 10, wherein the first catalyzed polyethylene polymer sheet comprises a first catalyzed polyethylene layer comprising a third catalyzed polyethylene having a density of about 0.91 g/cm³ to about 0.93 g/cm³ and a MI of about 3 g/10 min to about 7 g/10 min and a second catalyzed polyethylene layer comprising a fourth catalyzed polyethylene having a density of about 0.91 g/cm³ to about 0.93 g/cm³ and a MI of about 3 g/10 min to about 7 g/10 min and
the second catalyzed polyethylene polymer sheet comprises a third catalyzed polyethylene layer comprising a fifth catalyzed polyethylene having a density of about 0.91 g/cm³ to about 0.93 g/cm³ and a MI of about 3 g/10 min to about 7 g/10 min and a fourth catalyzed polyethylene layer comprising a sixth catalyzed polyethylene having a density of about 0.91 g/cm³ to about 0.93 g/cm³ and a MI of about 3 g/10 min to about 7 g/10 min.

12. The stretch film of claim 9, wherein
the first polymer buffer sheet comprises elastomer having a density of about 0.85 g/cm³ to about 0.89 g/cm³ and a MI of about 4 g/10 min to about 14 g/10 min,
the second polymer buffer sheet comprises elastomer having a density of about 0.85 g/cm³ to about 0.89 g/cm³ and a MI of about 4 g/10 min to about 14 g/10 min,
the first outer layer comprises ethylene propylene copolymer,
the second outer layer comprises ethylene propylene copolymer, and
the center layer comprises polypropylene having a density of about 0.88 g/cm³ to about 0.92 g/cm³ and a MI of about 3 g/10 min to about 7 g/10 min.

13. The stretch film of claim 9, wherein
the first polymer buffer sheet comprises ethylene propylene copolymer elastomer having a density of about 0.85 g/cm³ to about 0.89 g/cm³ and a MI of about 4 g/10 min to about 14 g/10 min,
the second polymer buffer sheet comprises ethylene propylene copolymer
the first outer layer comprises polypropylene having a density of about 0.88 g/cm³ to about 0.92 g/cm³ and a MI of about 3 g/10 min to about 7 g/10 min,
the second outer layer comprises polypropylene having a density of about 0.88 g/cm³ to about 0.92 g/cm³ and a MI of about 3 g/10 min to about 7 g/10 min, and
the center layer comprises elastomer having a density of about 0.85 g/cm³ to about 0.89 g/cm³ and a MI of about 4 g/10 min to about 14 g/10 min.

14. The stretch film of claim 13, wherein the first exterior sheet comprises a first catalyzed polyethylene having a density of about 0.93 g/cm³ to about 0.95 g/cm³ and a MI of about 1 g/10 min to about 7 g/10 min and
the second exterior sheet comprises a second catalyzed polyethylene having a density of about 0.91 g/cm³ to about 0.93 g/cm³ and a MI of about 2 g/10 min to about 4 g/10 min.

15. The stretch film of claim 14, wherein the first catalyzed polyethylene polymer sheet comprises a first catalyzed polyethylene layer comprising a third catalyzed polyethylene having a density of about 0.91 g/cm³ to about 0.93 g/cm³ and a MI of about 3 g/10 min to about 7 g/10 min and a second catalyzed polyethylene layer comprising a fourth catalyzed polyethylene having a density of about 0.91 g/cm³ to about 0.93 g/cm³ and a MI of about 3 g/10 min to about 7 g/10 min and
the second catalyzed polyethylene polymer sheet comprises a third catalyzed polyethylene layer comprising a fifth catalyzed polyethylene having a density of about 0.91 g/cm³ to about 0.93 g/cm³ and a MI of about 3 g/10 min to about 7 g/10 min and a fourth catalyzed polyethylene layer comprising a sixth catalyzed polyethylene having a density of about 0.91 g/cm³ to about 0.93 g/cm³ and a MI of about 3 g/10 min to about 7 g/10 min.

16. A multi-layer film comprising
a. a cling layer,
b. a non-cling layer,
c. a first interior layer,
d. a second interior layer, the second interior layer being incompatible with the first interior layer, and
e. a compatibilizing layer interposed between the first interior layer and the second interior layer,
wherein the film has a TD Tear of 450 g, a F-50 dart drop puncture resistance of 1000 g, and a thickness of less than or equal to about 41 gauge.

17. The multi-layer film of claim 16, wherein the film has a thickness of about 36 to about 40 gauge.

18. The multi-layer film of claim 16, wherein the film has a thickness of less than or equal to about 39 gauge.
